(19) United States
(12) Patent Application Publication
(10) Pub. No.: US 2024/0122795 A1
(43) Pub. Date: Apr. 18, 2024

(54) METHODS AND SYSTEMS FOR STIMULATING THYROID

(71) Applicant: Passy-Muir, Inc., Irvine, CA (US)

(72) Inventors: Alex Jolly, Newport Beach, CA (US); Cameron Jolly, Newport Beach, CA (US); Jose Comino, Irvine, CA (US)

(21) Appl. No.: 18/394,436

(22) Filed: Dec. 22, 2023

Related U.S. Application Data
(63) Continuation-in-part of application No. 17/887,299, filed on Aug. 12, 2022, now Pat. No. 11,850,205.
Application No. 17/887,299 is a continuation of application No. 17/305,282, filed on Jul. 2, 2021, now Pat. No. 11,413,214.
Application No. 17/305,282 is a continuation of application No. 16/853,477, filed on Apr. 20, 2020, now abandoned.
(60) Provisional application No. 62/836,195, filed on Apr. 19, 2019.

(51) Int. Cl. A61H 23/02

(52) U.S. Cl. CPC A61H 23/02; A61H 2201/1611; A61H 2201/165; A61H 2201/501; A61H 2201/5071; A61H 2205/04

(57) ABSTRACT

Proposed are methods and systems for thermally and/or vibrationally stimulating at least one of a laryngeal nerve or a thyroid using a neckband stimulator to treat at least one of a swallow disorder, a voice disorder, chronic cough, or thyroid related diseases. The neckband stimulator may include first and second thermal energy providers each providing a thermal energy on a surface thereof. The neckband stimulator may include first and second conductive pads configured to receive the thermal energy. The method may include placing the neckband at least partially around a neck of a patient, and moving the neckband such that the conductive pads contact different portions of the neck. The method may also include controlling the thermal energy providers to thermally conduct heat away from or to at least one of the laryngeal nerve or thyroid through the conductive pads.

### CROSS-REFERENCE TO RELATED APPLICATIONS

The application is a continuation-in-part of U.S. patent application Ser. No. 17/887,299, filed Aug. 12, 2022, which is a continuation of U.S. patent application Ser. No. 17/305,282, filed Jul. 2, 2021, now U.S. Pat. No. 11,413,214, which is a continuation of U.S. patent application Ser. No. 16/853,477, filed Apr. 20, 2020, now abandoned, which claims the priority of U.S. Provisional Patent Application No. 62/836,195, filed Apr. 19, 2019, the disclosures of each of which is incorporated in its entirety herein by reference.

### BACKGROUND

The present disclosure relates to human tissue stimulation and in particular to noninvasive vibration on the neck overlying the larynx to excite the laryngeal nerve to augment or reestablish swallowing control during rehabilitation of patients with dysphagia, and to treat voice disorders affecting the function of the laryngeal system, such as spasmodic dysphonia, and to treat chronic cough.

Dysphagia is a major swallowing disorder that effects the central nervous system, and the peripheral nervous system, thereby weakening neuromuscular control and effectively reducing the ability to properly swallow. Dysphagia may occur at any time across the lifespan. This impairment has many potential causes, including but not limited to neurologic disorders, degenerative disease processes, and anatomical changes. Dysphagia is characterized by difficulty swallowing, impaired ability to protect the airway during swallowing (penetration and aspiration), and impaired ability to transport a bolus of food or liquid from the mouth to the stomach. These difficulties may contribute to a risk for respiratory complications (pneumonia), dehydration, malnutrition, and may restrict social eating. Because of these negative impacts, it also may significantly impact quality of life for an individual.

An occasional cough is normal in that it helps to clear irritants and secretions from the lungs; however, when a cough lasts longer than eight weeks in adults and begins to interfere with daily functions, such as sleep and bladder control, then it may be diagnosed as a chronic cough. In children, this diagnosis may occur after four weeks of coughing. Chronic cough occurs in the upper airway of the respiratory system, and the condition may be caused by co-morbidities, such as asthma, post-nasal drip, or reflux. However, the mechanism is unknown. The cough reflex may be impaired by a disease condition that weakens the cough which could lead to muscle weakness or paralysis, or it may be secondary to laryngeal nerve involvement.

Spasmodic dysphonia is a disorder that may occur with neurological disorders or disease processes that impact laryngeal function and muscles of the voice. This disorder of the laryngeal system causes the muscles involved in voicing to periodically spasm, triggering increased tension and a distortion of the voice. The spasms cause interruptions and breaks in the voice. Causes of spasmodic dysphonia are unknown but may relate to such processes as anxiety, infection, or direct injury to the larynx. It is more common in women and occurs most often between the ages of 30-50 years.

Any neurologic disease or process that impacts laryngeal function may negatively impact swallowing, voicing, and airway functions such as cough and throat clear, or any function that originates within or requires function of the laryngeal system. Various functions within the laryngeal system occur due to stimulation of the afferent pathways which transmit impulses to the brain and are then interpreted for communication with the efferent system for movement. Current treatment for an impairment or changes of laryngeal function that is caused by various neurological disorders or laryngeal injury are typically long-term behavioral therapy or invasive treatment with the injection of foreign materials or medications into the muscles, nerves, or tissues of the larynx. However, various disorders, such as dysphagia, chronic cough, and voicing disorders, may be improved by innervation of the afferent system within the larynx including the branches of the vagus nerve, such as the recurrent laryngeal, superior laryngeal, and pharyngeal branches, and vibration is known to relax muscles and to provide stimulation to tissues being innervated offering an alternative treatment.

U.S. Pat. No. 8,388,561 describes a vibrotactile stimulator having a band 101 worn around a patient's neck and including a vibrator 102 positionable over the larynx to provide stimulation generally centered on the patient's neck. The vibrator 102 is an electric motor spinning an offset weight. While the '561 patent provides a potential method for addressing dysphagia, there remains a need for improved dysphagia therapy devices.

### SUMMARY

The present disclosure addresses the above and other needs by providing a vibrating laryngeal nerve exciting device which includes a collar holding a bridge, or a neckband, pressing soft tissue nerve exciters against a patient's neck providing a source of vibrations to stimulate the branches of the vagus nerve, such as the recurrent laryngeal, superior laryngeal, and pharyngeal branches. At least one exciter, and preferably two exciters, provide vibrations preferably adjustable between 30 Hz and 200 Hz and more preferably between 70 and 110 Hz and sufficiently strong to penetrate to the laryngeal nerve, for example, a pressure of 2-4 kPa or a vibration amplitude of 0.15 mm to 0.25 mm. The exciters may be held by the collar circling the neck, or by the neck band partially circling the neck. The therapy system includes a Personal Digital Assistant (PDA) device and software which wirelessly connects, monitors, and triggers the device. The system may be used to treat dysphagia, chronic cough, and spasmodic dysphonia.

One aspect provides software (e.g., a smartphone application) which wirelessly connects and triggers the device, for example, through a Bluetooth® protocol. The software may set at least one of the frequency of the device, intensity, therapy time, vibration time, heating time, cooling time, duration of rest period between vibration, a number of repetition of vibration and heating/cooling, and may allow for patients to provide feedback about the therapy. The software may also control at least one of the temperature of thermal energy (e.g., heating temperatures or cooling temperatures) to be applied to a patient, the heaters, or the coolers. A general state of health section allows the patient to diary how the patient is feeling before and after the therapy. The software allows clinicians to monitor the patient's progress. The clinician can see the device settings (frequency of the device, intensity, therapy time, vibration time, duration of rest period between vibration, heating or cooling temperatures), number of uses, whether therapy was completed, and the patient's feedback diary.

Another aspect is a method of stimulating a thyroid to treat one or more thyroid related diseases, the method comprising: providing a thyroid stimulation system comprising: a neckband stimulator comprising: a center portion, a first side portion and a second side portion disposed on opposite sides of the center portion, a first extension comprising a first surface and a second surface opposing each other, the first surface extending from the first side portion, a second extension comprising a first surface and a second surface opposing each other, the first surface of the second extension extending from the second side portion, a first support coupled to the second surface of the first extension, a second support coupled to the second surface of the second extension, the first support and the second support opposing each other and spaced apart by a distance, a first exciter coupled to the first support, a second exciter coupled to the second support, a first electrical circuit and a second electrical circuit configured to respectively control the first exciter and the second exciter, a first pad coupled to the first exciter, and a second pad coupled to the second exciter, wherein each of the first side portion and the second side portion comprises a first region and a second region closer to the center portion than the first region, wherein each first region comprises a housing mounted thereon and respectively accommodating the first electrical circuit or the second electrical circuit, and wherein each first region is larger in size than each second region due to the housing; placing the neckband stimulator at least partially around a neck of a patient; moving the neckband stimulator such that the first pad and the second pad respectively contact a first portion and a second portion of the neck of the patient different from each other and adjacent to the thyroid of the patient; and vibrationally exciting the thyroid of the patient, the vibrationally exciting including generating vibration, by the first exciter and the second exciter, and conducting, by the first exciter and the second exciter, the generated vibration to the first portion and the second portion of the neck.

In the above method, the first support and the second support are not coupled to each other to form an open front of the neckband stimulator facing the center portion. In the above method, the first side portion and the second side portion are coupled to each other to form a closed front of the neckband stimulator. In the above method, the center portion is divided by two sub-portions configured to be detached from or attached to each other. In the above method, the first extension and the second extension respectively extend from the first side portion and the second side portion in a curved manner. In the above method, at least one of a length of the first side portion or a length of the second side portion is adjustable.

In the above method, the neckband stimulator further comprises: a first thermal energy provider coupled to at least one of the first support or the first exciter, the first thermal energy provider comprising a first surface and a second surface opposing each other, the second surface of the first thermal energy provider facing the first support, the first thermal energy provider configured to provide a thermal energy on the first surface thereof; a second thermal energy provider coupled to at least one of the second support or the second exciter, the second thermal energy provider comprising a first surface and a second surface opposing each other, the second surface of the second thermal energy provider facing the second support, the second thermal energy provider configured to provide a second thermal energy on the first surface thereof, the second thermal energy provider spaced apart from the first thermal energy provider; the first pad in thermal communication with the first surface of the first thermal energy provider, the first pad comprising a first thermally conductive pad; and the second pad in thermal communication with the first surface of the second thermal energy provider, the second pad comprising a second thermally conductive pad, the method further comprising: thermally stimulating the thyroid of the patient by controlling at least one of the first thermal energy provider or the second thermal energy provider to provide at least one of the first thermal energy or the second thermal energy and thermally conduct heat away from or to the thyroid of the patient through at least one of the first thermally conductive pad or the second thermally conductive pad.

In the above method, vibrationally exciting the thyroid of the patient is performed while thermally stimulating the thyroid of the patient. In the above method, the vibrationally exciting and the thermally stimulating are alternately and repeatedly performed. In the above method, the vibrationally exciting and the thermally stimulating are sequentially performed. The above method may further comprise: providing one or more temperature sensors adjacent to or on the at least one of the first exciter or the second exciter; and measuring a temperature of the at least one of the first exciter or the second exciter using the one or more temperature sensors, wherein controlling the at least one of the first thermal energy provider or the second thermal energy provider is performed based on the measured temperature.

In the above method, the first exciter is coupled to the first surface of the first thermal energy provider so as to be interposed between the first thermal energy provider and the first thermally conductive pad, and wherein the second exciter is coupled to the first surface of the second thermal energy provider so as to be interposed between the second thermal energy provider and the second thermally conductive pad. In the above method, at least one of the first thermal energy provider or the second thermal energy provider comprises an opening at least partially accommodating the respective first or second exciter therein. In the above method, the first exciter is coupled to the second surface of the first thermal energy provider, and wherein the second exciter is coupled to the second surface of the second thermal energy provider. In the above method, at least one of the first thermal energy provider or the second thermal energy provider comprises an opening at least partially accommodating the respective first or second exciter therein.

In the above method, the first electrical circuit is configured to control both the first thermal energy provider and the first exciter, and wherein the second electrical circuit is configured to control both the second thermal energy provider and the second exciter. The above method may further comprise: providing one or more temperature sensors on at least one of the first thermally conductive pad, the second thermally conductive pad, the first side portion, the second side portion, or the center portion; and measuring a temperature of the neck of the patient using the one or more temperature sensors, wherein controlling the at least one of the first thermal energy provider or the second thermal energy provider is performed based on the measured temperature.

The above method may further comprise: providing one or more temperature sensors adjacent to or on the at least one of the first thermal energy provider or the second first thermal energy provider; and measuring a temperature of the at least one of the first thermal energy provider or the second first thermal energy provider, wherein controlling the at least one of the first thermal energy provider or the second thermal energy provider is performed based on the measured temperature. The above method may further comprise: generating an alarm in response to the measured temperature exceeding a threshold.

The above method may further comprise: controlling, by at least one of the first electrical circuit or the second electrical circuit, at least one of the first thermal energy provider or the second thermal energy provider by applying at least one of voltage, current, or power to the first thermal energy provider or the second thermal energy provider. In the above method, the at least one of the first thermal energy provider or the second first thermal energy provider comprises a thermoelectric heater or cooler configured to generate a heating or cooling energy based on at least one of voltage, current, or power received from an electrical circuit and provide the heating or cooling energy to the respective first or second thermally conductive pad.

In the above method, the first thermal energy provider comprises a first thermoelectric heater or cooler configured to generate a first heating or cooling energy based on at least one of a first voltage, a first current, or a first power received from a first electrical circuit and provide the first heating or cooling energy to the first thermally conductive pad, and wherein the second thermal energy provider comprises a second thermoelectric heater or cooler configured to generate a second heating or cooling energy based on at least one of a second voltage, a second current, or a second power received from a second electrical circuit and provide the second heating or cooling energy to the second thermally conductive pad.

In the above method, the at least one of the first thermal energy provider or the second first thermal energy provider comprises a heat exchanger in thermal communication with the respective first or second thermally conductive pad and configured to receive a heating or cooling energy from an external thermal energy source and exchange the received heating or cooling energy with the respective first or second thermally conductive pad. In the above method, the neckband stimulator comprises one or more heat pipes disposed inside the neckband stimulator and in thermal communication with the heat exchanger and the external thermal energy source such that the heating or cooling energy is transferred from the external thermal energy source to the heat exchanger or dissipated from the heat exchanger to the external thermal energy source through the one or more heat pipes.

The above method may further comprise: providing one or more temperature sensors adjacent to or on the one or more heat pipes; and measuring a temperature of the one or more heat pipes using the one or more temperature sensors, wherein controlling the at least one of the first thermal energy provider or the second thermal energy provider is performed based on the measured temperature. In the above method, the neckband stimulator comprises one or more inlets and one or more outlets in thermal communication with the heat exchanger and the external thermal energy source through the one or more heat pipes, the method further comprising: receiving, via the one or more inlets, a fluid having a first temperature from the external thermal energy source; flowing the fluid from the external thermal energy source to the heat exchanger through the one or more heat pipes such that the fluid exchanges heat with the heat exchanger and the respective thermally conductive pad to output a temperature-adjusted fluid having a second temperature different from the first temperature; and dissipating the temperature-adjusted fluid from the heat exchanger to the external thermal energy source through the one or more outlets.

In the above method, the thyroid stimulation system further comprises a chiller or a heat pump coupled to the neckband stimulator via one or more fluid pipes external to the neckband stimulator. The above method may further comprise: providing a first temperature sensor adjacent to or on the first thermal energy provider; providing a second temperature sensor adjacent to or on the first thermal energy provider; measuring a first temperature of the first thermal energy provider; measuring a second temperature of the second thermal energy provider; in response to the first temperature being different from the second temperature, causing a temperature gradient between the first thermal energy provider and the second thermal energy provider; and transferring a thermal energy difference caused by the temperature gradient, by the first thermal energy provider and the second thermal energy provider, to or from the patient's neck.

The above method may further comprise: prior to moving the neckband stimulator, coupling a first transdermal pad impregnated with medication to the first pad and coupling a second transdermal pad impregnated with the medication to the second pad, wherein the moving comprises moving the neckband stimulator such that the first transdermal pad and the second transdermal pad respectively contact a first portion and a second portion of the neck of the patient different from each other, and wherein vibrationally exciting the thyroid comprises: generating vibration, by the first exciter and the second exciter, and conducting, by the first exciter and the second exciter, the generated vibration to the patient's neck to facilitate the medication to be delivered to the thyroid.

The above method may further comprise: prior to moving the neckband stimulator and prior to thermally stimulating the thyroid, coupling a first transdermal pad impregnated with medication to the first pad and coupling a second transdermal pad impregnated with the medication to the second pad, wherein thermally stimulating the thyroid comprises: providing the first thermal energy and the second thermal energy respectively to the first transdermal pad and the second transdermal pad to facilitate the medication to be delivered to the thyroid.

In the above method, controlling the at least one of the first thermal energy provider or the second thermal energy provider comprises: wirelessly controlling, by a personal information communication device, at least one of the first thermal energy provider or the second thermal energy provider to provide at least one of the first thermal energy or the second thermal energy and thermally conduct heat away from or to the laryngeal nerve. In the above method, the first support and the second support are not coupled to each other to form an open front of the neckband stimulator facing the center portion. In the above method, the first side portion and the second side portion are coupled to each other to form a closed front of the neckband stimulator.

Another aspect is a thyroid stimulation system comprising: a neckband stimulator comprising: a center portion, a first side portion and a second side portion disposed on opposite sides of the center portion, a first extension comprising a first surface and a second surface opposing each other, the first surface extending from the first side portion, a second extension comprising a first surface and a second surface opposing each other, the first surface of the second extension extending from the second side portion, a first support coupled to the second surface of the first extension, a second support coupled to the second surface of the second extension, the first support and the second support opposing each other and spaced apart by a distance, a first exciter coupled to the first support, a second exciter coupled to the second support, a first electrical circuit and a second electrical circuit configured to respectively control the first exciter and the second exciter, a first pad coupled to the first exciter, and a second pad coupled to the second exciter, wherein each of the first side portion and the second side portion comprises a first region and a second region closer to the center portion than the first region, wherein each first region comprises a housing mounted thereon and respectively accommodating the first electrical circuit or the second electrical circuit, and wherein each first region is larger in size than each second region due to the housing, wherein the neckband stimulator is configured to be at least partially around a neck of a patient such that the first pad and the second pad respectively contact a first portion and a second portion of the neck of the patient different from each other and adjacent to the thyroid of the patient, and wherein the neckband stimulator is configured to vibrationally excite the thyroid of the patient, the vibrationally exciting including generating vibration, by the first exciter and the second exciter, and conducting, by the first exciter and the second exciter, the generated vibration to the first portion and the second portion of the neck.

Another aspect is a non-transitory computer readable recording medium storing instructions, when executed by one or more processors, causing the one or more processors to perform at least part of the above methods. Another aspect is a personal information communication apparatus configured to wirelessly control the thyroid stimulation system. Another aspect is a server system configured to control at least one of the personal information communication apparatus or the thyroid stimulation system.

Any of the features of an aspect is applicable to all aspects identified herein. Moreover, any of the features of an aspect is independently combinable, partly or wholly with other aspects described herein in any way, e.g., one, two, or three or more aspects may be combinable in whole or in part. Further, any of the features of an aspect may be made optional to other aspects. Any aspect of a method can comprise another aspect of a system, and any aspect of a system can be configured to perform a method of another aspect.

### BRIEF DESCRIPTION OF THE DRAWINGS

The above and other aspects, features and advantages of the present disclosure will be more apparent from the following more particular description thereof, presented in conjunction with the following drawings.

FIG. 1A shows a front view of a laryngeal nerve exciter according to one embodiment of the present disclosure.

FIG. 1B shows a top view of the laryngeal nerve exciter of FIG. 1A.

FIG. 1C shows a rear view of the laryngeal nerve exciter of FIG. 1A.

FIG. 2 shows an end effector of the laryngeal nerve exciter according to one embodiment of the present disclosure.

FIG. 3 shows a top view of a second embodiment of a laryngeal nerve exciter according to the present disclosure.

FIG. 4 shows a neckband laryngeal nerve exciter according to another embodiment of the present disclosure on a patent.

FIG. 5 shows a top view of the neckband laryngeal nerve exciter of FIG. 4.

FIG. 6 shows a perspective view of the neckband laryngeal nerve exciter of FIG. 4.

FIG. 7 shows a nerve exciter of the neckband laryngeal nerve exciter according to the present disclosure.

FIG. 8 shows an adhesive pad of the neckband laryngeal nerve exciter according to the present disclosure.

FIG. 9 shows a laryngeal nerve exciting system according to the present disclosure.

FIG. 10A and FIG. 10B illustrate a neckband stimulator according to another embodiment.

FIG. 11A and FIG. 11B respectively show cross-sectional views of an example assembled configuration and an example disassembled configuration of the first thermal energy provider coupled to the thermally conductive pad.

FIG. 11C and FIG. 11D respectively show front perspective and rear perspective views of an example disassembled configuration of the first thermal energy provider coupled to the thermally conductive pad.

FIG. 12 illustrates a neckband laryngeal nerve stimulator 200 according to another embodiment.

FIG. 13 illustrates a neckband laryngeal nerve stimulator 300 according to another embodiment.

FIG. 14A and FIG. 14B illustrate a neckband laryngeal nerve stimulator 400 according to another embodiment.

FIG. 15A and FIG. 15B illustrate a neckband laryngeal nerve stimulator 500 according to another embodiment.

FIG. 16A and FIG. 16B illustrate a neckband laryngeal nerve stimulator 600 according to another embodiment.

FIG. 17 illustrates a neckband laryngeal nerve stimulator 700 according to another embodiment.

FIG. 18A and FIG. 18B illustrate an example configuration of a thermal energy provider according to some embodiments.

FIG. 18C illustrates another example configuration of a thermal energy provider according to some embodiments.

FIG. 18D illustrates an example configuration of a thermal energy provider.

FIG. 19A illustrates an example configuration of a thermal energy provider and a heatsink.

FIG. 19B illustrates another example configuration of a thermal energy provider and a heatsink.

FIG. 20A-FIG. 20C illustrate an example neckband stimulator according to some embodiments.

FIG. 21 illustrates an example anatomy of a thyroid and a trachea of a person.

Corresponding reference characters indicate corresponding components throughout the several views of the drawings.

### DETAILED DESCRIPTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement.

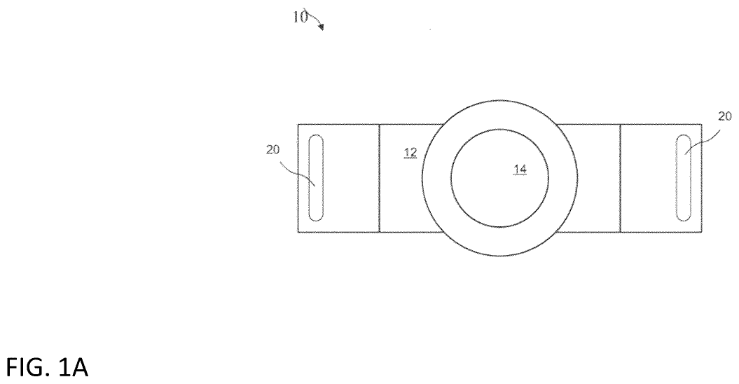

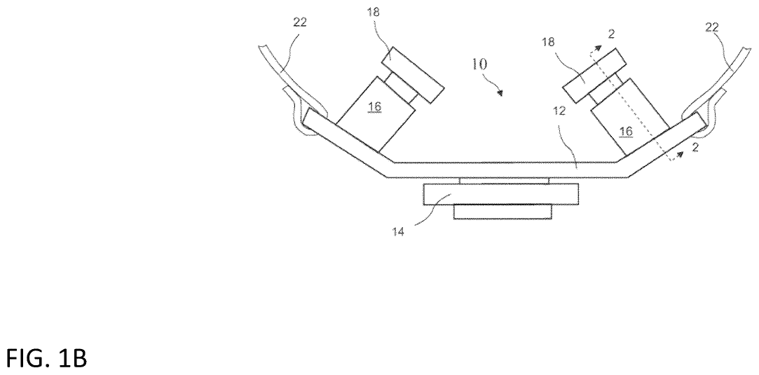

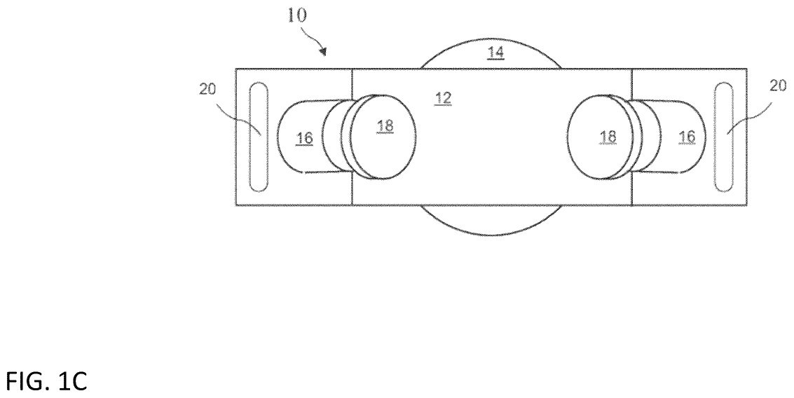

A front view of a laryngeal nerve exciter 10 according to the present disclosure is shown in FIG. 1A, a top view of the laryngeal nerve exciter 10 is shown in FIG. 1B, and a rear view of the laryngeal nerve exciter 10 is shown in FIG. 1C. The laryngeal nerve exciter 10 includes a bridge 12, an exciter 14, effector sleeves 16, end effectors 18, strap slots 20, and a strap 22. The exciter 14 is preferably a solenoid or a voice coil, or any device capable of generating vibrations at various frequencies, for example, vibrations between 30 and 200 Hz and preferably between 70 and 110 HZ and sufficiently strong to reach the laryngeal nerve for example, a pressure of 2-4 kPa or a vibration amplitude of 0.15 mm to 0.25 mm.

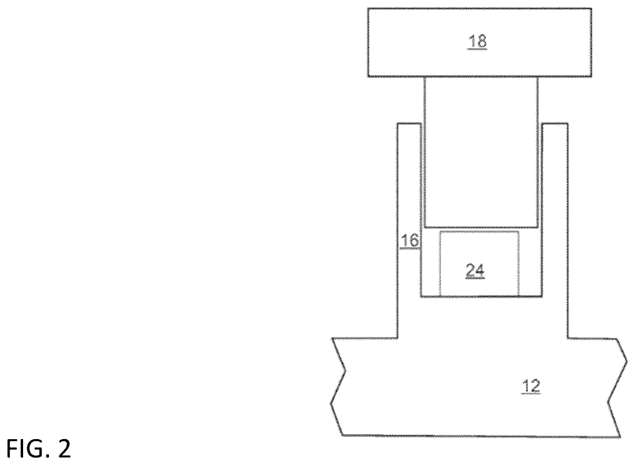

The end effector 18 of the laryngeal nerve exciter 10 is shown in FIG. 2. A force sensor 24 resides under each end effector 18 and provides force information to allow adjusting the tightness of the strap 22.

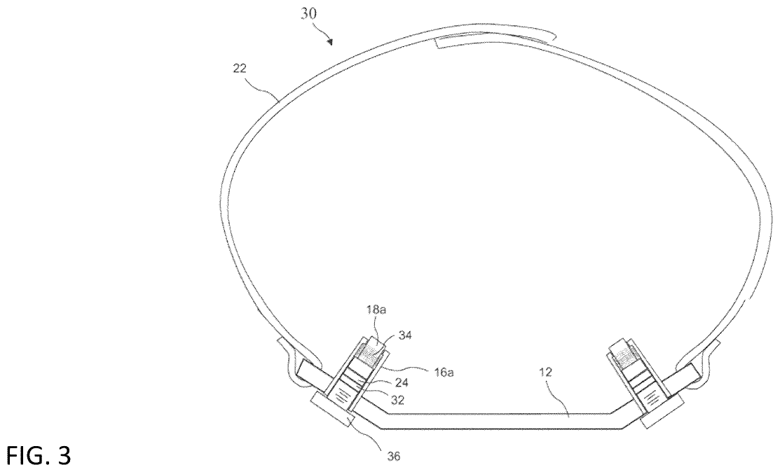

A top view of a second embodiment of a laryngeal nerve exciter 30 is shown in FIG. 3. The laryngeal nerve exciter 30 includes end effectors 18a held inside sleeves 16a and springs (or a resilient material) 34 holding the end effectors 18a against transducers 32. An adjust screw 36 presses the transducer 32 and end effector 18a against the spring 34 allowing adjustment of the end effectors 18a against the patient's neck without adjusting the strap 22. The transducers 32 may both vibrate the end effectors 18a to stimulate the laryngeal nerve and may sense a patient's attempt to swallow, and may sense stimulation by the other end effector 18a. The laryngeal nerve exciter 30 may include the force sensor 24 under the effector 16a. In another embodiment, the end effectors 18a may be fixedly attached to the moving part of the transducers 32 and no spring 34 is required.

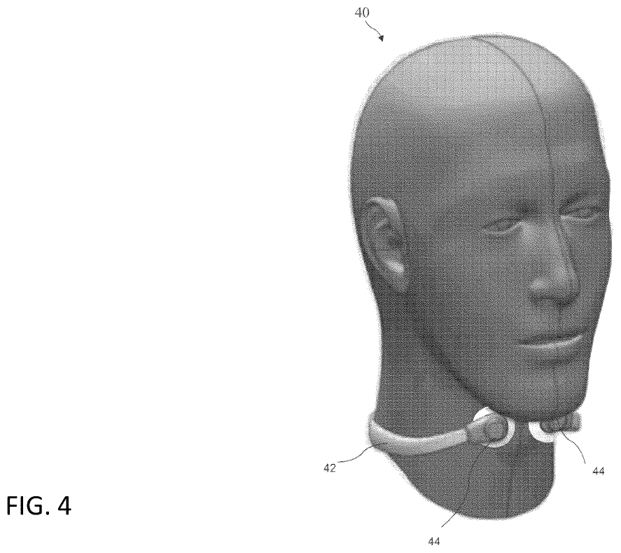

FIG. 4 shows a neckband laryngeal nerve exciter (neckband trainer) 42 on a patient 40. The neckband trainer 42 does not press against the patient's throat providing greater comfort for the patient. Two exciters 44 are pressed against sides of the neck. The exciters 44 preferably receive up to 10 Watts (five Watts per exciter). The neckband trainer 42 provides pressure to the area where the exciters 44 contact the neck. The force of the exciters 44 against the neck is measured and an alarm is generated if the force exceeds a threshold.

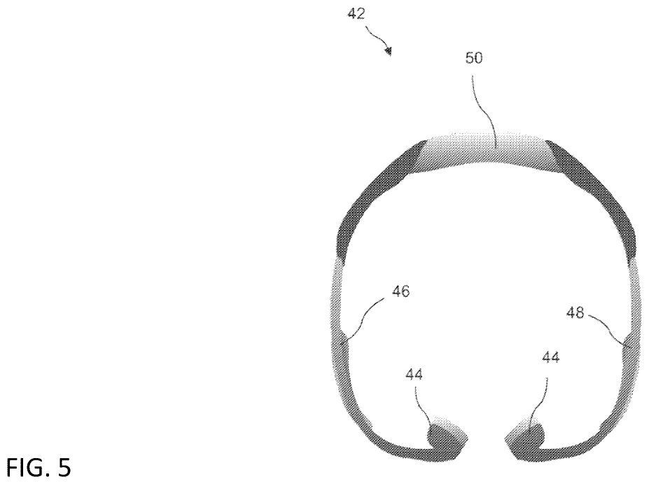

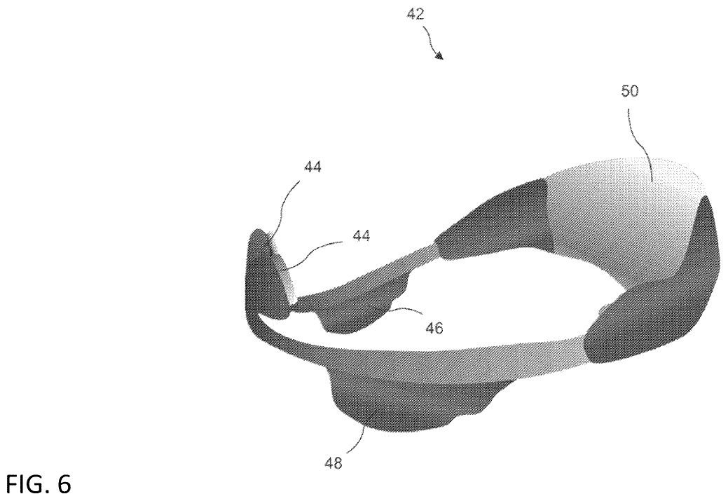

FIG. 5 shows a top view of the neckband trainer 42 and FIG. 6 shows a perspective view of the neckband trainer 42. The neckband trainer 42 includes the exciters 44, a circuit 46, and battery compartments 48 and 50. The neckband trainer 42 includes a charging port for charging batteries and is adjustable for individual patients.

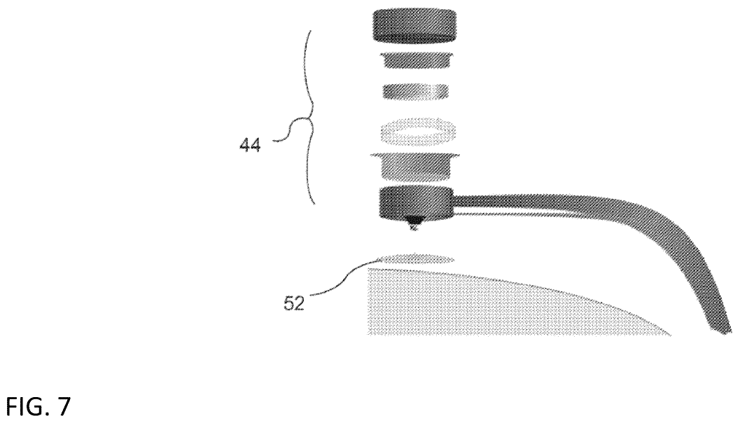

FIG. 7 shows a nerve exciter 44 of the neckband laryngeal nerve exciter.

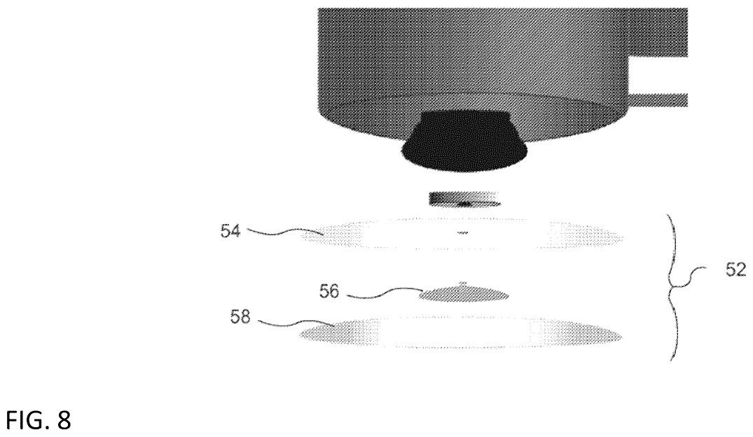

FIG. 8 shows an adhesive pad 52 of the neckband trainer 42. The adhesive pad 52 comprises a top adhesive pad 54, a plastic snap 56, and a bottom adhesive pad 58. The adhesive pad 52 may snap onto the exciter 44 to retain the adhesive pad 52 against the patient's neck.

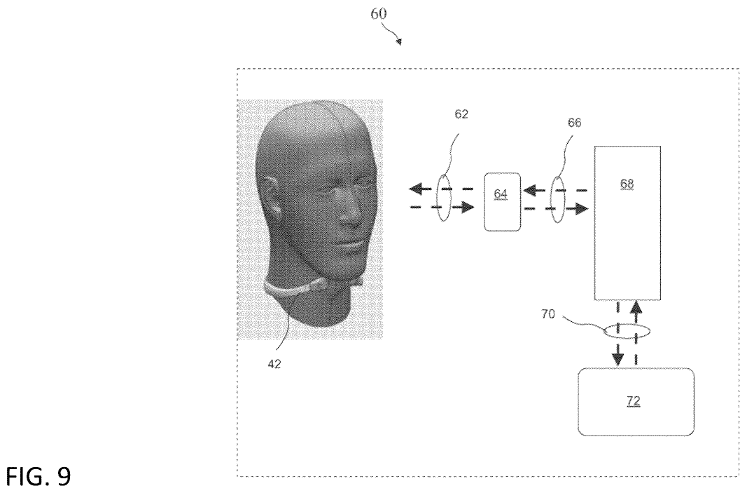

A laryngeal nerve exciter system 60 is shown in FIG. 9. The system 60 utilizes a software Application (App) residing in a Personal Digital Assistant (PDA) 64 which triggers, and monitors the neckband trainer 42 through a Bluetooth® interface 62. The interface 62 may include frequency, intensity, therapy time, vibration time, duration of rest period between vibration, the temperature of the heaters or coolers (to be described below), and allows for patients to provide feedback about the therapy.

The PDA 64 may communicate with a secure server 68 through the Internet or any other suitable connection including wireless or wired connections 66 providing signals include frequency, intensity, therapy time, vibration time, duration of rest period between vibration, clinician calibration, as well as temperature control of the heating and cooling module (to be described below), and allows for patients to provide feedback about the therapy.

The secure server 68 may communicate with a work station 72 over the Internet or any other suitable connection including wireless or wired connections 70 providing signals include frequency, intensity, therapy time, vibration time, duration of rest period between vibration, and clinician calibration, as well as a temperature control of the heating and cooling module, and allows for patients to provide feedback about the therapy to the clinician.

The App may set the frequency of the neckband trainer 42, intensity, therapy time, vibration time, duration of rest period between vibration, as well as control of heating and cooling, and allows for patients to provide feedback about the therapy. Measurements made by the neckband trainer 42 (e.g., force measured by the exciters) may be provided to the PDA 46 via the Bluetooth® connection. Further, the system 60 may allow clinicians to monitor the patient's progress. The clinician will be able to see the device settings, frequency of the device, intensity, therapy time, vibration time, duration of rest period between vibration, number of uses, whether therapy was completed, as well as current temperature and the patient feedback. A general state of health section for the patient may be provided to indicate how the patient is feeling before and after the therapy. The PDA 64 may be a smartphone.

### Thermal or Vibrational Stimulation of Laryngeal Nerve or Thyroid

Various embodiments provide methods and systems for thermally and/or vibrationally stimulating at least one of a laryngeal nerve or a thyroid using a neckband stimulator to treat at least one of a swallow disorder, a voice disorder, chronic cough, or thyroid related diseases based on at least one of vibration, heating, or cooling (including alternating at least two of vibration, heating, or cooling) of a neck (e.g., front portion) of a patient.

Peripheral nerve injury (PNI) is a common chronic trauma seen in the clinic and is characterized by both permanent sensory impairment and motor dysfunction. Unlike the central nervous system (CNS), the neurons and axons of neurons of the peripheral nervous system (PNS) may regenerate, allowing for the recovery of function after peripheral nerve damage. The vagus nerve is a cranial nerve and follows the general rule that cranial nerve ganglia are a part of the (PNS). The laryngeal nerve is a branch of the vagus nerve including both sensory and motor neurons which innervate many muscles associated with the larynx.

The superior laryngeal nerve (SLN) branches from the vagus nerve adjacent to the carotid bifurcation as it descends down the neck towards the superior thyroid artery. The superior laryngeal nerve includes two branches, the external branch (including motor neurons that innervate the cricothyroid muscle), and internal superior laryngeal nerve (including sensory fibers that innervate the laryngeal mucosa superior to the vocal cords). The external branch of the superior laryngeal nerve follows the superior thyroid artery, whereas the fibers of the internal branch of the superior laryngeal nerve weave through the thyrohyoid membrane innervating the laryngeal mucosa superior to the vocal cords. The recurrent laryngeal nerve (RLN) anatomy differs depending on its laterality. The right RLN branches from the vagus nerve adjacent to the right subclavian artery, while the left RLN lies inferior to the aortic arch. Both the right and left recurrent laryngeal nerves travel superiorly to the posterior of the thyroid where both then enter the larynx. Once in the larynx, the recurrent laryngeal nerve is referred to as the inferior laryngeal nerve, innervating all the intrinsic musculature of the larynx except for the cricothyroid muscle. This nerve is the primary motor supply to vocal production. Inferior to the vocal cords, sensory innervation is all provided by the recurrent laryngeal nerves.

Most frequently the part of the neurons that are damaged in the PNS are the axons. Regeneration of the axon and proper muscle innervation are a consequence of interactions between the various cell types and the presence of compounds critical for nerve development and regeneration. Critical cell types necessary to induce regeneration and proper connection at the neuromuscular junction include the neuron, the muscle cells, glial cells including myelinating Schwann cells, resident immune cells such as macrophages type (M1) and (M2).

After peripheral nerve injury, autocrine and paracrine signaling of the injured tissue triggers the inflammatory response. The resultant presence of cytokines and other extracellular signals from the injury results in Wallerian degeneration and induces the expression of neurotrophic growth-promoting factors such as “neurotrophins, the GDNF family of neurotrophic factors, and the neuropoetic cytokines” in the PNS. Before the release of the neurotrophic factors, the damaged cells or surrounding cells produce signals triggering both the disintegration of axon of the damaged neuron and resultant removal of the cellular debris (a process known as a Wallerian degeneration). After RLN injury, the distal portions of axons separate from the soma and degenerate in a series of steps called Wallerian degeneration.

Regeneration is a consequence of interactions between the various tissues, cell types and components that are critical for nerve development and regeneration such as neurons, glial and resident immune cells are important in regeneration in response to nerve injury. Critical cell types to induce regeneration and proper connection at the neuromuscular junction include the neuron, the muscle cells, myelinating Schwann cells, macrophages type (M1) and (M2). (M1) macrophages induce inflammation and aid the clearing of cellular debris in response to peripheral nerve injury. (M2) macrophages release anti-inflammatory agents and neurotrophic factors which enhance proximal nerve regeneration.

A problem that currently exists in the field is the preservation of neuronal survival, axonal outgrowth, and synapse formation during nerve regeneration. Various embodiments provide a therapeutic strategy to treat laryngeal peripheral nerve injuries to induce proper nerve regeneration that may be used alone or in tandem with other treatments or symptom relief.

At least some embodiments of the present disclosure address problems that currently exist in the field by facilitating preservation of neuronal survival, axonal outgrowth, and synapse formation during nerve regeneration. Proper functional nerve regeneration may be induced by factors such as (a) the modification of the regenerative microenvironment, such as inhibition of inflammatory factors, reducing oxidative stress levels and accelerating myelin fragment clearance; (b) promotion of the activation of intrinsic growth programs of injured nerves via increasing intracellular transcriptional factors; (c) the prevention of neurofibroma formation at the lesion site to guide regenerated axons to connect with their original targets; and (d) the balance between growth-promoting and growth-limiting molecules, such as trophic factors, neuregulin 1, Chondroitin sulfate proteoglycans (CSPGs), and myelin-associated glycoprotein. Thus, focusing on the correlative factors involved in nerve regeneration can provide a promising therapeutic strategy for the treatment of PNI.

Vibration can clear cell debris caused by local tissue damage and the associated Wallerian degeneration. Blood and cytoplasm are a shear-thinning fluid, meaning that its viscosity decreases when shear rate increases. Viscosity is a macroscopic outcome of the dynamics of molecules constituting a liquid. According to Stokes-Einstein equation, the translation diffusion coefficient is inversely proportional to liquid viscosity (for a given molecular radius and temperature).

Furthermore, generally in liquids, viscosity is a result of intermolecular attractive forces (cohesive forces) between compounds across layers of flow. Consequently, as the temperature increases the viscosity decreases because of the energy of the compound is so great that it can more easily overcome those attractive forces. Therefore, heat and vibration make the shear-thinning fluid less viscous. Consequently, the rate of diffusion will increase in response to both or either heat and vibration.

Heat shock proteins are a family of proteins that have been shown to provide protection against environmental stressors such as heat, oxidative, and chemical stress. Unsurprisingly this family of proteins is generally expressed by cells exposed to heat and mechanical stress. Heat exposure prior to neural injury has been identified as producing a decrease in injury diameter in motor neurons of the PNS, but not cold exposure. Indicating a protective role of heat treatment against injury-induced increases in apoptosis, mitochondrial ROS, cytosolic ROS, caspase-3, and -9 in the neurons. Therefore, heat shock proteins induced protective actions against injury-mediated increases of oxidative stress, excitotoxicity, and apoptosis in neural and glial cells. Research has shown that heat shock proteins may act as chaperone that facilitate the proper refolding of damaged proteins. In addition, studies of one heat shock protein (HSP27) have revealed that the protein responds to cellular stress conditions other than heat shock; for example, oxidative stress and chemical stress. During oxidative stress, HSP27 functions as an antioxidant, lowering the levels of reactive oxygen species (ROS) by raising levels of intracellular glutathione and lowering the levels of intracellular iron. Furthermore, at least one heat shock protein (HSP27) is a regeneration-associated protein that accelerates axonal growth after peripheral nerve injury. These anti-apoptotic properties in response to chemicals (perceived as stress by cells) has had major ramifications on the success of certain chemotherapies such as doxorubicin and gemcitabine.

Cold can trap proteins and macrophages, prevent immune cells from migrating, and reduce inflammation, In addition, (M2) macrophages produce neurotrophic compounds in response to cold.

Unlike the central nervous system (CNS), the neurons and axons of neurons of the peripheral nervous system (PNS) may regenerate, allowing for the recovery of function after peripheral nerve damage. The laryngeal nerve is a peripheral nerve that branches from the vagus nerve and includes both sensory and motor neurons, which innervate many muscles associated with the larynx. Most frequently, the part of the neurons that are damaged in the PNS are the axons. Regeneration of the axon and proper muscle innervation are a consequence of interactions between the various cell types and the presence of compounds critical for nerve development and regeneration. Critical cell types necessary to induce regeneration and proper connection at the neuromuscular junction include the neuron, the muscle cells, glial cells including myelinating Schwann cells, and resident immune cells such as macrophages type (M1) and (M2).

Some embodiments promote the modification of the regenerative microenvironment so as to reduce inflammation and oxidative stress by cooling the laryngeal nerve and surrounding tissue. Heat with vibration can accelerate myelin fragment clearance by diffusion of the broken-down material. This will occur more rapidly when the device is applied closer in time to the injury. Furthermore, the increase in temperature may increase differentiation and recruitment of macrophages (M1) at the site of the injury and the surrounding tissue.

Some embodiments promote the activation of intrinsic growth factors of injured nerves through increasing intracellular transcriptional factors by inducing recruitment of (M2) macrophages at the site of the injury and the surrounding tissue and can prevent neurofibroma formation at the lesion site to guide regenerated axons to connect with their original targets.

In some embodiments, temperature controlling devices including heaters and/or coolers are attached to the exciters to provide an increase in temperature up to about 120° F. or to cool to about 30° F. below body temperature, to heat or cool the nervous tissue and the surrounding tissue through contact with the patient's skin. The exciters, heaters or coolers may be held by the collar circling the patient's neck, or by the neck band partially circling the neck. The therapy system may include a personal digital assistant (PDA) device and software which wirelessly connects, monitors, and triggers the device. The system may be used to treat dysphagia, chronic cough, and spasmodic dysphonia and disorder cause by damage and or dysfunction of the laryngeal nerve.

Some embodiments may increase the expression of proteins necessary to prevent nerve damage, such as by applying at least one of heat or vibration prior to surgery. Also, this device may be used after traumatic nerve injury to aid in the cellular diffusion process by applying at least one of heat or vibration, which has the effect of supplementing the Wallerian degeneration process. Some embodiments may decrease inflammation caused by peripheral nerve injury and preserve the muscle motor endplate by cooling the neck and increasing (M2) macrophage recruitment.

Some embodiments may increase the tissue temperature up, for example, about 120° F. and cool, for example, about 30° F. below body temperature, by heating and cooling the patient's nervous and surrounding tissue respectively, by contact with the patient's neck. The above temperatures are merely examples, and other heating temperatures and other cooling temperatures can also be used. The exciters, heaters, or coolers may be held by the collar circling the neck or the neckband partially circling the neck. The therapy system may include a personal digital assistant (PDA) device and software that wirelessly connects, monitors, and triggers the device. The system may be used to treat dysphagia, chronic cough, spasmodic dysphonia, and disorders caused by damage and or dysfunction of the laryngeal nerve.

### Various Stimulator Systems

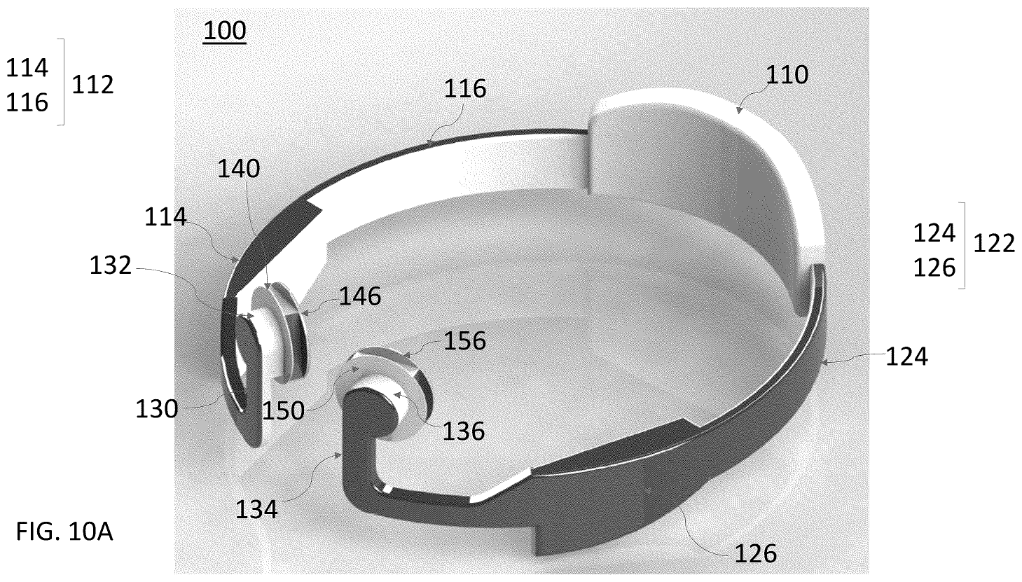

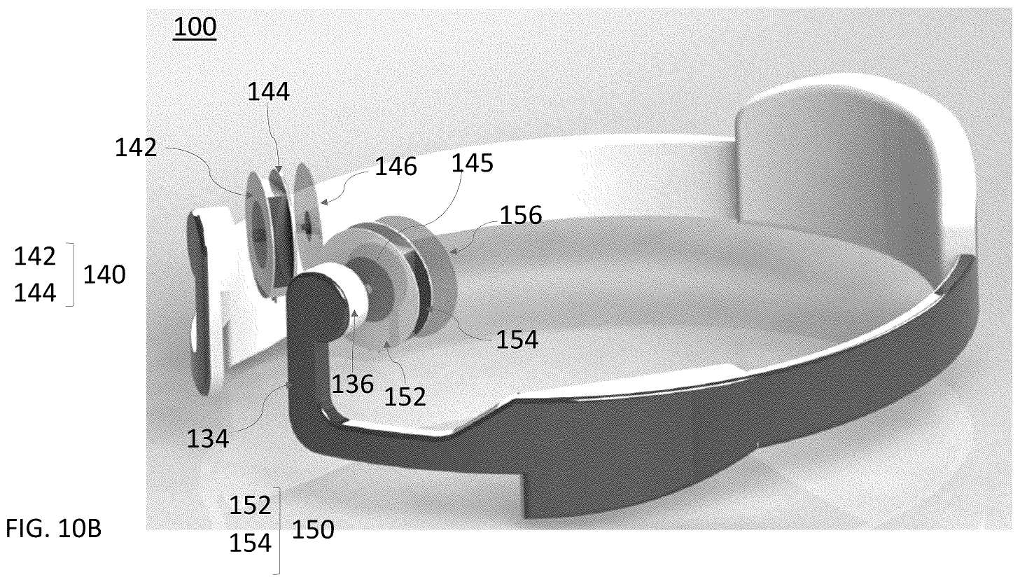

FIG. 10A and FIG. 10B illustrate a neckband stimulator (hereinafter to be interchangeably used with a neckband stimulation system) 100 according to another embodiment. The neckband stimulator 100 may thermally stimulate (e.g., cooling or heating) and/or vibrationally stimulate at least one of a laryngeal nerve or a thyroid of the neck of a patient. For example, the neckband stimulator 100 may only thermally stimulate at least one of the laryngeal nerve or the thyroid without vibrational stimulation. As another example, the neckband stimulator 100 may only vibrationally stimulate at least one of the laryngeal nerve or the thyroid without thermal stimulation.

As another example, the neckband stimulator 100 may sequentially vibrationally and thermally (in this order) stimulate at least one of the laryngeal nerve or the thyroid. As another example, the neckband stimulator 100 may sequentially thermally and vibrationally (in this order) stimulate at least one of the laryngeal nerve or the thyroid. As another example, the neckband stimulator 100 may alternately vibrationally and thermally stimulate at least one of the laryngeal nerve or the thyroid.

As another example, the neckband stimulator 100 may vibrationally stimulate at least one of the laryngeal nerve or the thyroid while thermally stimulating at least one of the laryngeal nerve or the thyroid. The thermal stimulation and the vibrational stimulation may be performed simultaneously or substantially simultaneously. The thermal stimulation and the vibrational stimulation may be performed sequentially while at least partially overlapping each other. For example, one of the thermal stimulation or the vibrational stimulation may start first, and the other stimulation may start, while the first stimulation is still being performed, after a predetermined period of time passes.

The neckband stimulator 100 may include a first thermal energy provider 140, a second thermal energy provider 150, a first thermally conductive pad 146, a second thermally conductive pad 156, a center portion 110, a first side portion 112, a second side portion 122, a first extension 130, a second extension 134, a first support 132, and a second support 136.

The first conductive pad 146 and the second conductive pad 156 may contact the patient's neck. At least one of the first conductive pad 146 or the second conductive pad 156 may include a thermally conductive material. The thermally conductive material may include, but is not limited to, copper, aluminum, carbon sheets, silicon thermal pads, or aluminum nitride, or a combination thereof. At least one of the first conductive pad 146 or the second thermally conductive pad 156 may include a material having a relatively low electric conductivity while having a relatively high thermal conductivity.

Similar to the FIG. 5 embodiment, the first side portion 112 includes a first region 114 and a second region 116. The second side portion 122 includes a first region 124 and a second region 126. Each of the first regions 114/124 may be thicker than each second region 116/126. The first region 114 of the first side portion 112 may include a housing accommodating an electrical circuit configured to control at least one of the first thermal energy provider 140 or a first exciter (described above). The first region 124 of the first side portion 122 may include a housing accommodating an electrical circuit configured to control at least one of the second thermal energy provider 150 or a second exciter (described above).

The center portion 110 may be thicker than each of the first side portion 112 and the second side portion 122. The center portion 110 may include a battery compartment configured to accommodate a battery that provides power to at least one of the exciters, the electrical circuits, the first thermal energy provider 140, or the second thermal energy provider 150.

The first extension 130 may extend from the first side portion 112 in a curved manner. The second extension 134 may extend from the second side portion 122 in a curved manner. The first extension 130 may form a first angle with respect to the first side portion 112. The first angle may be in the range of about 45 degrees to about 90 degrees. The second extension 134 may form a second angle with respect to the second side portion 122. The second angle may be the same as or different from the first angle. The second angle may be in the range of about 45 degrees to about 90 degrees. The above angles are merely examples, and the present disclosure is not limited thereto. For example, at least one of the first angle or the second angle may be smaller than about 45 degrees or greater than about 90 degrees.

In some embodiments, at least one of a length of the first side portion 112 or a length of the second side portion 122 may be fixed. In other embodiments, at least one of a length of the first side portion 112 or a length of the second side portion 122 may be adjustable.

The first support 132 may at least partially support the first thermal energy provider 140. In some embodiments, the first support 132 may accommodate a first exciter. In other embodiments, the first support 132 may not include a first exciter. The first support 132 may function as a first heat exchanger being in thermal communication with a first thermally conductive pad 146 and an external thermal energy source disposed outside the neckband stimulator 100. For example, the first heat exchanger may receive a fluid (in liquid or gaseous phase) having a first temperature from the external thermal energy source and provide the received fluid to the first thermally conductive pad 146 to directly or indirectly conduct heat to the first thermally conductive pad 146 to thermally stimulate at least one of the laryngeal nerve or the thyroid. The first heat exchanger may transfer a temperature-adjusted fluid, that has exchanged heat with the first thermally conductive pad 146, to the external thermal energy source to conduct heat away from the first thermally conductive pad 146. The temperature-adjusted fluid may have a second temperature different from the first temperature. The fluid may be liquid water, water vapor, liquid coolant, gaseous coolant, ambient air, or a combination thereof.

The second support 136 may at least partially support the second thermal energy provider 150. The second support 136 may or may not accommodate a second exciter depending on the embodiment. The second support 136 may function as a second heat exchanger being in thermal communication with a second thermally conductive pad 156 and an external thermal energy source disposed outside the neckband stimulator 100. For example, the second heat exchanger may receive a fluid (in liquid or gaseous phase) having a first temperature from the external thermal energy source and provide the received fluid to the second thermally conductive pad 156 to conduct heat to the first thermally conductive pad 156 to thermally stimulate at least one of the laryngeal nerve or the thyroid. The second heat exchanger may transfer a temperature-adjusted fluid, that has exchanged heat with the second thermally conductive pad 156, to the external thermal energy source to conduct heat away from the second thermally conductive pad 146. The temperature-adjusted fluid may have a second temperature different from the first temperature.

The first thermal energy provider 140 may be coupled to the first support 132 and the first thermally conductive pad 146. In some embodiments, the first thermal energy provider 140 may generate a thermal energy based on at least one of voltage, current, or power received from an electrical circuit, and provide the thermal energy to the first thermally conductive pad 146. The first support 132 may include a first exciter configured to generate vibration to vibrationally stimulate at least one of the laryngeal nerve or the thyroid. The first thermal energy provider 140 may generate a thermal energy while, before, or after the first exciter generates the vibration.

In some embodiments, the first thermal energy provider 140 may function as a first heat exchanger, alone or together with at least part of the first support 132, being in thermal communication with the first thermally conductive pad 146 and an external thermal energy source disposed outside the neckband stimulator 100. In these embodiments, the first thermal energy provider 140 may not generate a thermal energy, and instead, the first thermal energy provider 140 may receive a thermal energy from an external thermal energy source and transfer the received thermal energy to the first thermally conductive pad 146. The first thermal energy provider 140 may transfer the received thermal energy to the first thermally conductive pad 146, for example, by way of conduction. As described with respect to the first support 132, the first thermal energy provider 140 may be in fluid communication with the first thermally conductive pad 146 and the external energy source.

The second thermal energy provider 150 may be coupled to the second support 136 and the second thermally conductive pad 156. In some embodiments, the second thermal energy provider 150 may generate a thermal energy based on at least one of voltage, current, or power received from an electrical circuit, and provide the generated thermal energy to the second thermally conductive pad 156. The second support 136 may include a second exciter configured to generate vibration to vibrationally stimulate the laryngeal nerve. The second thermal energy provider 150 may generate a thermal energy while, before, or after the second exciter generates the vibration.

In some embodiments, the second thermal energy provider 150 may function as a second heat exchanger, alone or together with at least part of the second support 136, being in thermal communication with the second thermally conductive pad 156 and an external thermal energy source disposed outside the neckband 100. In these embodiments, the second thermal energy provider 150 may not generate a thermal energy, and instead, the second thermal energy provider 150 may receive a thermal energy from an external thermal energy source and transfer the received thermal energy to the second thermally conductive pad 156 to thermally stimulate at least one of the laryngeal nerve or the thyroid. The second thermal energy provider 150 may transfer the received thermal energy to the second thermally conductive pad 156, for example, by way of conduction. As described with respect to the second support 134, the second thermal energy provider 150 may be in fluid communication with the second thermally conductive pad 156 and the external energy source.

At least one of the first thermal energy provider 140 or the second thermal energy provider 150 may provide a heating energy associated with a temperature range of about 90° F.-about 120° F. to stimulate at least one of a laryngeal nerve or a thyroid on the patient's neck (alone or together with vibration described above). The above temperature ranges are merely examples, and other temperature ranges may also be used. For example, in response to a measured temperature of a patient's neck being lower than a first predetermined body temperature range, at least one of the first thermal energy provider or the second thermal energy provider may provide a heating energy associated with a temperature range equal to or greater than the first predetermined body temperature range. The first predetermined body temperature range may be, for example, about 80° F.-about 100° F., about 85° F.-about 110° F., about 90° F.-about 120° F., about 95° F.-about 130° F., about 100° F.-about 140° F., or all other temperature ranges therebetween. The above temperature ranges may efficiently stimulate a laryngeal nerve and/or a thyroid by applying a heating energy associated with the temperature ranges alone or in combination with vibrational stimulation.

At least one of the first thermal energy provider 140 or the second thermal energy provider 150 may provide a cooling energy associated with a temperature range of about 70° F.-about 30° F. to stimulate at least one of a laryngeal nerve or a thyroid on the patient's neck (alone or together with vibration described above). The above temperature ranges are merely examples, and other ranges may also be used. For example, in response to a measured temperature of a patient's neck being lower than a second predetermined body temperature range, at least one of the first thermal energy provider 140 or the second thermal energy provider 150 may provide a cooling energy associated with a temperature range equal to or less than the second predetermined body temperature range. The second predetermined body temperature range may be, for example, about 90° F.-about 60° F., about 85° F.-about 55° F., about 80° F.-about 50° F., about 75° F.-about 45° F., about 70° F.-about 40° F., about 65° F.-about 35° F., about 60° F.-about 30° F., about 55° F.-about 25° F., about 50° F.-about 20° F., or all other temperature ranges therebetween. The above temperature ranges may efficiently stimulate a laryngeal nerve and/or a thyroid by applying a cooling energy associated with the temperature ranges alone or in combination with vibrational stimulation.

The above temperature ranges associated with the thermal energy may be manually adjusted or automatically adjusted by a controller in the stimulator or using a personal digital assistant (PDA) or other personal communication device such as a smartphone, a tablet, or a laptop, etc., communicating with the stimulator. The PDA or other personal information communication device may include software or other processor configured to control at least one of the electrical circuit or the thermal energy provider in connection with at least one of thermal stimulation or vibrational stimulation. For example, the software or the processor may set at least one of a frequency of the stimulator, intensity, therapy time, vibration time, heating time, cooling time, duration of rest period between vibration, a number of repetition of vibration and heating/cooling. The above settings are merely examples, and other settings for more efficient treatment may also be used. The software or the processor may allow for patients to provide feedback about the therapy. The software or the processor may also control at least one of the temperature of thermal energy (e.g., heating temperatures or cooling temperatures) to be applied to a patient, the heaters, or the coolers. The software or the processor may allow clinicians to monitor the patient's progress. The software or the processor may allow the clinician to see the device settings described above, number of uses, whether therapy was completed, and the patient's feedback diary. The PDA or other personal communication device may wirelessly communicate data with the stimulator, for example, via a short range communication protocol such as Bluetooth. In these embodiments, the electrical circuit may be configured to wirelessly communicate data with the PDA or other personal communication device. The first and second predetermined body temperature ranges may be saved in a memory of the stimulator or set by a personal digital assistant (PDA) or other personal communication device such as a smartphone, a tablet, or a laptop, etc., communicating with the stimulator.

In some embodiments, as shown in FIG. 10B, the first and second thermal energy providers 140 and 150 may respectively include a first thermal energy generator 142 and a second thermal energy generator 152 each configured to generate a thermal energy (heating or cooling energy) based on at least one of current, voltage, or power received from the electrical circuit described above. For example, at least one of the first thermal energy generator 142 or the second thermal energy generator 152 may generate a heating energy based on a first level of current and a cooling energy based on a second level of current different from the first level of current. Each thermal energy generator 142/152 may provide the heating energy or cooling energy directly or indirectly to the respective first or second conductive pad 146/156. The thermal energy generator may include a thermoelectric heater or cooler such as a Peltier module.

In some embodiments, one of the first and second thermal energy providers 140 and 150 may include a thermal energy generator, and the other thermal energy provider may not include a thermal energy generator. In these embodiments, the other thermal energy provider may include a heat exchanger that receives a thermal energy from an external thermal energy source and exchanges the received thermal energy with the corresponding conductive pad.

At least one of the first or second thermal energy provider 140 and 150 may include an optional exciter 144 or 154. In these embodiments, the electrical circuit may control at least one of the thermal energy generator or the exciter to thermally stimulate and/or vibrationally excite at least one of a laryngeal nerve or a thyroid.

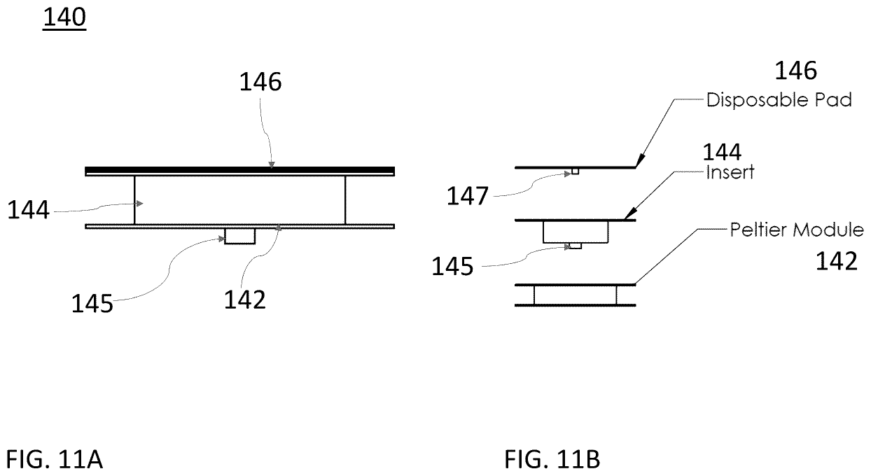

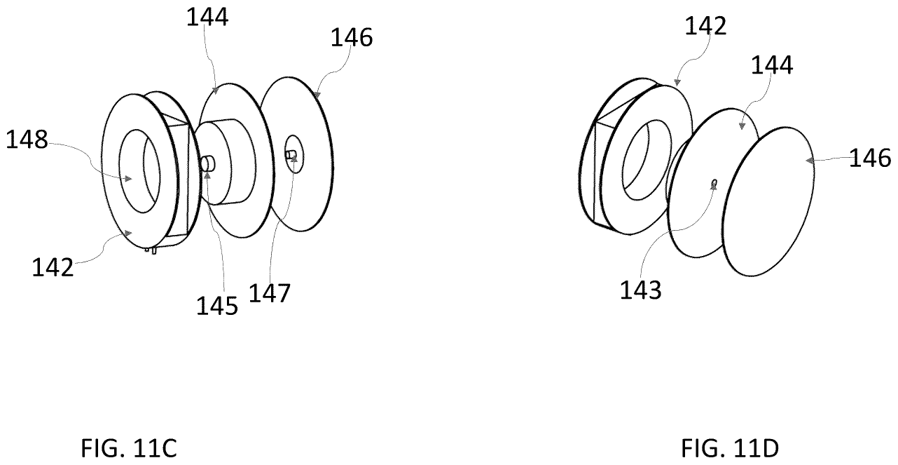

FIG. 11A and FIG. 11B respectively show cross-sectional views of an example assembled configuration and an example disassembled configuration of the first thermal energy provider 140 (142/144) coupled to the thermally conductive pad 146. FIG. 11C and FIG. 11D respectively show a front perspective view and a rear perspective view of an example disassembled configuration of the first thermal energy provider 140 (142/144) coupled to the thermally conductive pad 146. The second thermal energy provider 150 may have the same configuration. While FIG. 11B shows that the thermal energy generator 142 is a Peltier module, the present disclosure is not limited thereto, and other thermal energy generators may also be used.

The exciter 144 may be inserted into the thermal energy generator 142 via an opening 148. The conductive pad 146 may include a protrusion 147 configured to be snapped into an opening 143 of the exciter 144. In these embodiments, the thermal energy generated by the thermal energy generator 142 may be indirectly transferred or conducted to the thermally conductive pad 146 via an optional top plate of the exciter 144. The exciter 144 may include a protrusion configured to be snapped into an opening in the support 132 (see FIG. 10A).

The top plate of the exciter 144 may be removed such that the thermal energy generated by the thermal energy generator 142 may be directly transferred or conducted to the thermally conductive pad 146. The optional exciter 144 may be completely removed such that the thermal energy generated by the thermal energy generator 142 may be directly transferred or conducted to the thermally conductive pad 146.

In some embodiments, the exciter 144 may be disposed below the thermal energy generator 142. In these embodiments, the thermal energy generated by the thermal energy generator 142 may be directly transferred or conducted to the thermally conductive pad 146.

While FIG. 11C and FIG. 11D show that the elements 142, 144, and 146 have a circular shape, other configurations such as triangular, rectangular, pentagonal, or other polygonal shapes can also be used.

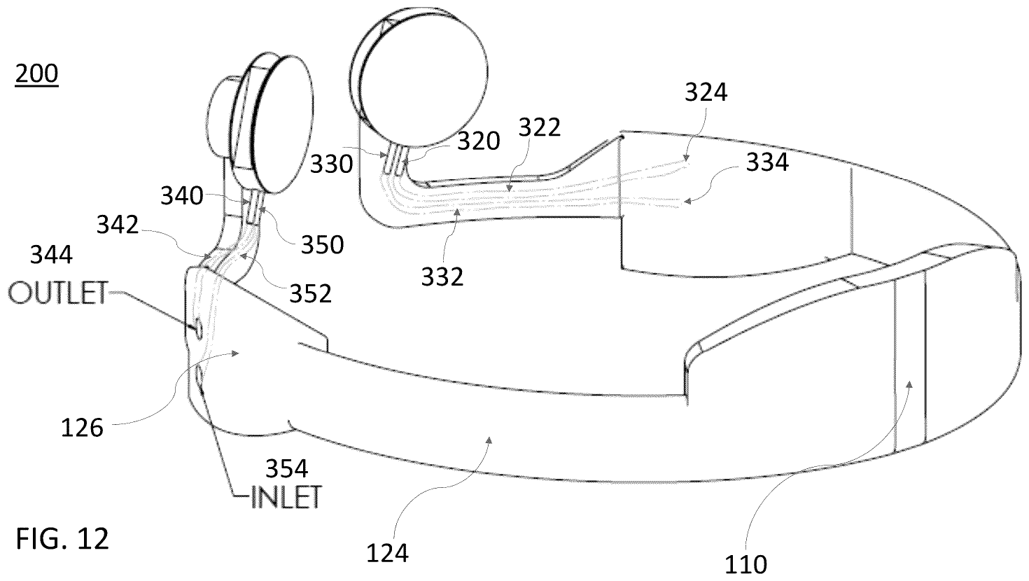

FIG. 12 illustrates a neckband stimulator 200 according to another embodiment. The stimulator 200 is similar to the stimulator 100 of FIG. 11 except that the stimulator 200 includes first heat pipes 322/332, second heat pipes 342/352, first inlet and outlet 324/344, and second inlet and outlet 344/354. The first heat pipes 322/332 may be respectively coupled to a first inlet valve 320 and a first outlet valve 330 of the first thermal energy provider on one side, and coupled to the first inlet 324 and the first outlet 334 on the other side. At least one of the first thermal energy provider 140 or the second thermal energy provider 150 may exchange heat with an external thermal energy source. While FIG. 12 shows two heat pipes in each side, the present disclosure is not limited thereto, and three or more heat pipes may be provided. There may be the same number or different numbers of heat pipes coupled to the inlet and outlet. For example, two heat pipes may be provided for the outlet, and one heat pipe may be provided for the inlet. As another example, two heat pipes may be provided for each of the inlet and the outlet.

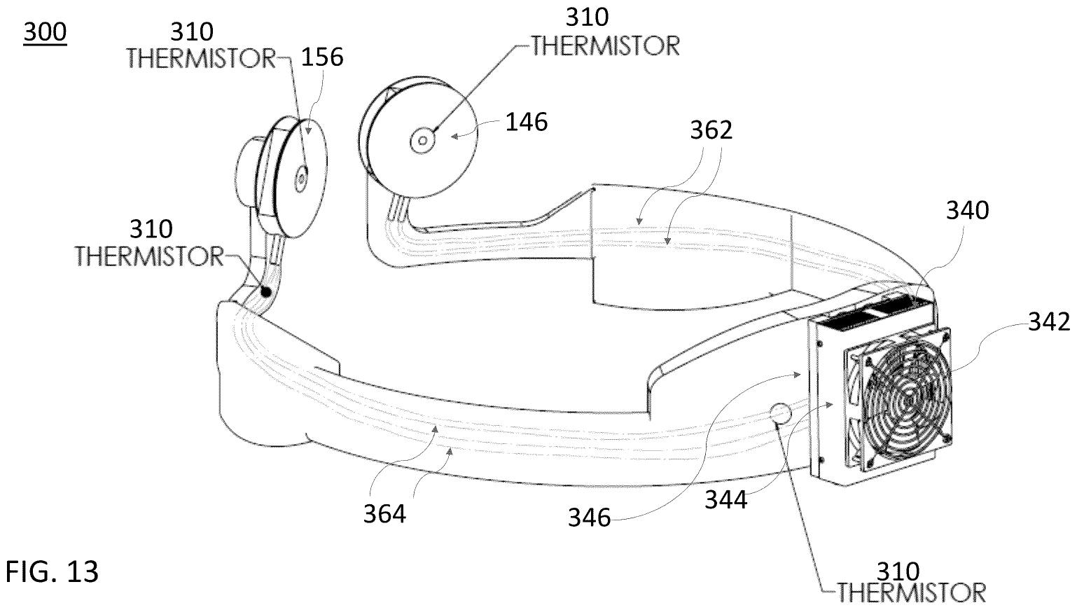

In some embodiments, the external thermal energy source may be the environment. In these embodiments, at least one of the first thermal energy provider 140 or the second thermal energy provider 140 may exchange heat with ambient air in the environment. The stimulator 200 may include a blowing fan attached to the inlet 324/354 and the outlet 334/344 and configured to move ambient air having a first temperature into the inlet 324/354 and blow a heat-exchanged air having a second temperature different from the first temperature out of (or suck from) the outlet 334/344. The stimulator 200 may include one or more radiators coupled to the inlet and outlets for more efficient heat exchange (to be described in more detail with reference to FIGS. 13-15B).

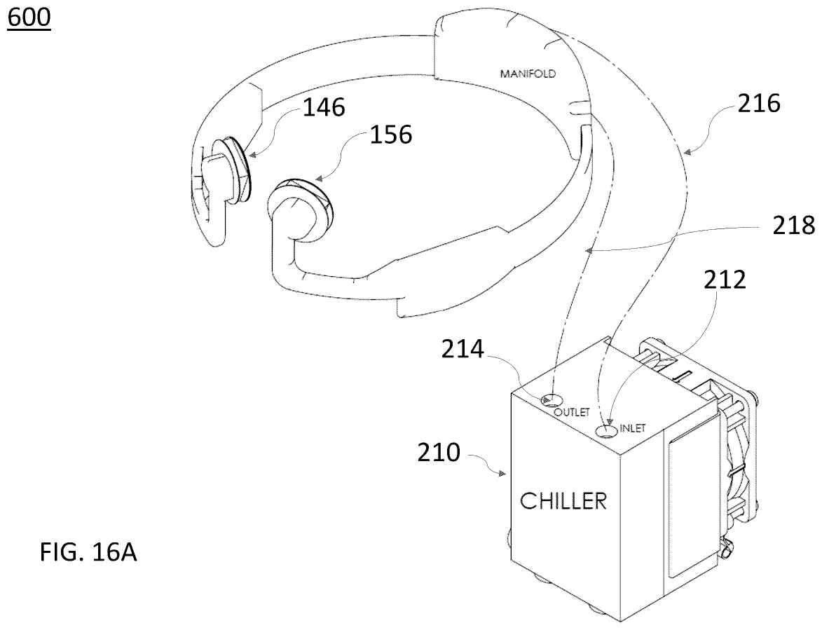

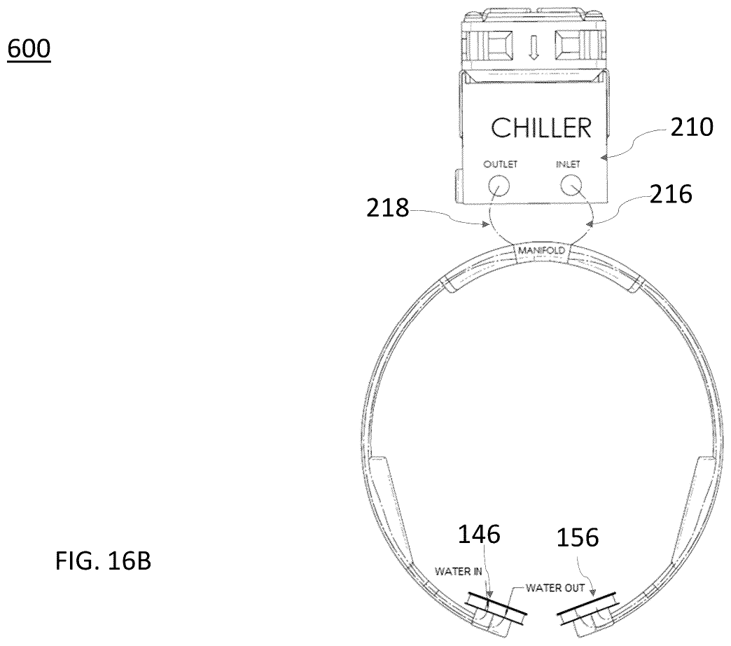

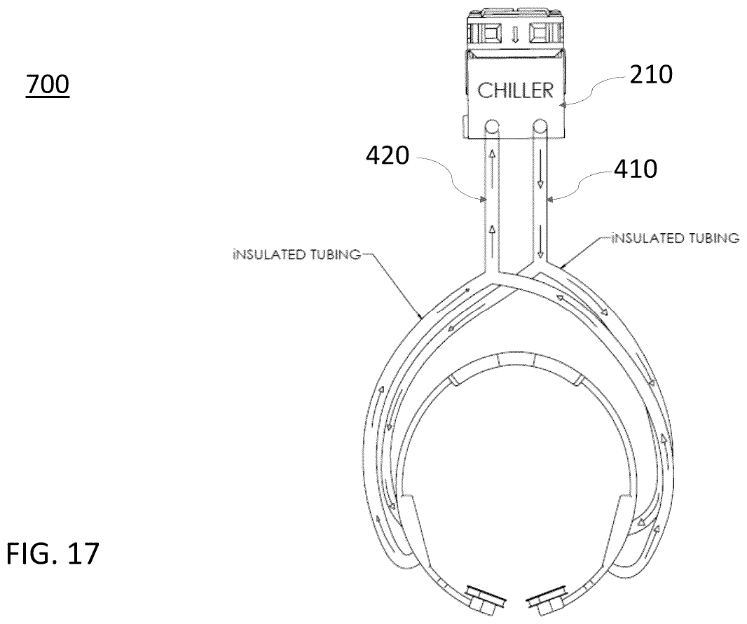

In some embodiments, the external thermal energy source may be a chiller or a refrigerating device. In these embodiments, the chiller may exchange heat with the thermal energy provider by flowing a fluid having a first temperature into the inlet 324/354 and receiving a heat-exchanged fluid having a second temperature different from the first temperature from the outlet 334/344 (to be described in more detail with reference to FIGS. 16A-17).

While FIG. 12 shows that the inlets 324/354 and the outlets 334/344 are disposed on the second region 126 of the side portion, the present disclosure is not limited thereto. For example, the inlets 324/354 and the outlets 334/344 may be disposed on the first region 126 of the side portion or on the center portion 110. In these embodiments, longer heat pipes may be provided to reach the first region 126 or the center portion 110. In the FIG. 12 embodiment, the thermal energy generator may be omitted and only a heat exchanger may be provided to exchange heat between the conductive pads 146/156 and the external energy source.

FIG. 13 illustrates a neckband stimulator 300 according to another embodiment. The stimulator 300 is similar to the stimulator 200 of FIG. 12 except that the stimulator 300 includes one or more temperature sensors 310, and a radiator 340, and longer heat pipes 362/364 coupled to the radiator 340. The one or more temperature sensors 310 may be disposed on at least one of the conductive pad 146/156, the side portion 120, or the center portion 110, to measure a temperature on a neck of a patient (e.g., at least one of front neck, side neck, or rear neck). In these embodiments, at least one of the electrical circuit or the PDA may control the thermal energy provider and/or the external thermal energy source to adjust the amount of thermal energy (e.g., by adjusting the temperature of the incoming fluid) provided to the conductive pads 146/156 based on the measured temperature of the patient's neck.

The one or more temperature sensors 310 may be disposed on at least one of the heat pipes 362/364, or to be adjacent to the thermal energy provider or the electric circuit to measure temperatures of the heat pipes 362/364, the thermal energy provider, or the electric circuit. The one or more temperature sensors 310 may be disposed on at least one of the inlet heat pipes or the outlet heat pipes. In these embodiments, at least one of the electrical circuit or the PDA may control the thermal energy provider and/or the external thermal energy source to adjust the amount of thermal energy provided to the conductive pads 146/156 based on the measured temperature of one or more of the heat pipes, the thermal energy provider, or the electric circuit.

The temperature sensors may include, for example, a thermistor (a thermally sensitive semiconductor which increases or decreases in resistance as the temperature varies) or a thermocouple (which senses change in temperature by varying the voltage created between two different metals) which may report the temperature to the PDA. For example, because a thermistor is a thermally sensitive semiconductor whose resistance changes as the temperature varies, the changes in resistance are a function of the change in temperature, which are then registered as a numeric value. The numeric value may be converted into the desired units of Celsius, Kelvin or Fahrenheit, which may be then reported to the PDA.

The temperature reading may be utilized as a tool by a nurse, a speech language pathologist, other attending medical staff, the patient, or the patient's family member aiding in patient's treatment or comfort. The attending medical staff, the patient, the patient family member, or a person otherwise using the stimulator may operate the stimulator directly or using a PDA to adjust the temperature. When a sensed temperature exceeds a predetermined temperature threshold, at least one of the electrical circuit or the PDA may generate an alarm and/or cut off power to the thermal energy generator. The electrical circuit may include one or more resistors that measure current and act as a current overload protection cut off switch when the measured current exceeds a certain threshold.

The radiator 340 may include radiator pipes (not shown in FIG. 13) disposed inside and in thermal communication with the thermal energy provider or the conductive pads 146/156. The radiator 340 may use a fluid flowing inside the heat pipes as a medium to exchange heat with the thermal energy provider and/or the conductive pads 146/156. The fluid may include, but is not limited to, liquid water, water vapor, liquid coolant, gaseous coolant (or coolant in gas phase), air, a combination thereof. The radiator 340 may include a fan 342 that blows air into or out of the radiator pipes for more efficient heating or cooling. The fan 342 may be coupled to a housing 344 of the radiator 340 using various attachment mechanisms, including, but not limited to, a magnet, adhesive, Velcro, screw, rivet, etc. The radiator 340 may be attached to the center portion of the stimulator 300 using attaching mechanism 346. The attaching mechanism 344 may include a magnet, adhesive, Velcro, screw, rivet, etc. The attaching mechanism 344 may include one or more through-holes that pass through the heat pipes to be coupled to the radiator pipes disposed inside the housing 344 of the radiator 340. In some embodiments, instead of the through-holes in the attaching mechanism 344, the housing 344 of the radiator 340 may include one or more openings (not shown), for example, in a sidewall of the housing 344 that can receive the heat pipes 362/344 to be coupled to the radiator pipes disposed inside the housing 344 of the radiator 340.

Similar to the FIG. 12 embodiment, the thermal energy generator may be omitted and only a heat exchanger may be provided to exchange heat between the conductive pads 146/156 and the external energy source in the FIG. 13 embodiment.

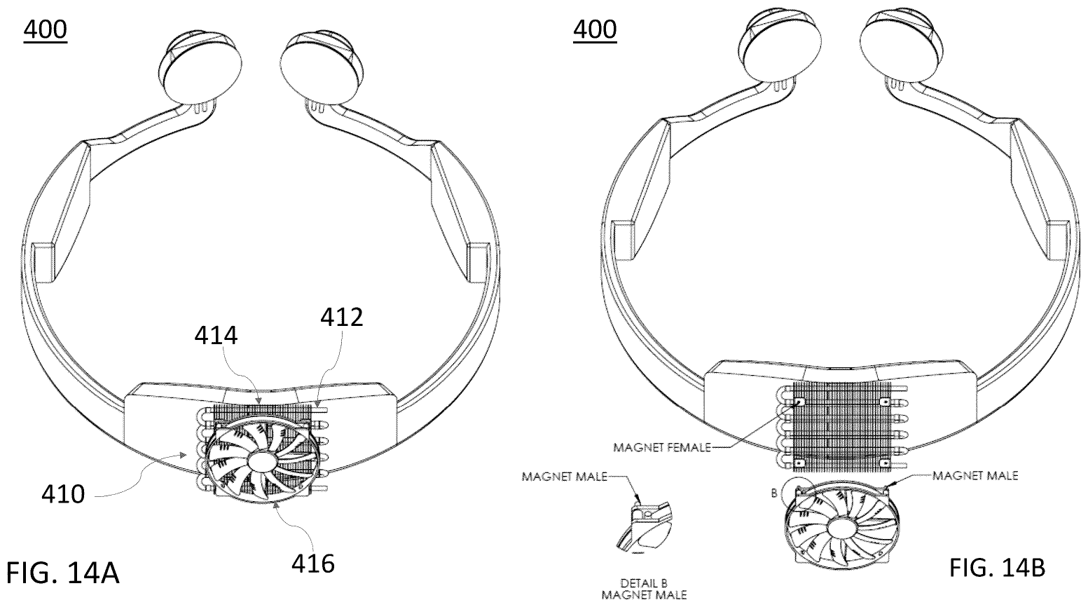

FIG. 14A and FIG. 14B illustrate a neckband stimulator 400 according to another embodiment. The stimulator 400 is similar to the stimulator 300 of FIG. 13 except that the stimulator 400 includes a radiator 410 that includes radiator pipes 412 and heat dissipating fins 414 exposed to the environment. FIG. 14A shows an example assembled state of the radiator 410, and FIG. 14B shows a partially disassembled state of the radiator 410.

In some embodiments, the radiator pipes 412 may be integrally formed with the stimulator 400 (e.g., injection-molded with the center portion). The radiator pipes 412 may also be coupled to the stimulator using various attachment mechanism described above such as magnet, Velcro, adhesive, screw, rivet, etc. The radiator 410 may also include a fan 416. The fan 416 may be coupled to the radiator fins using various attachment mechanism described above such as magnet, Velcro, adhesive, screw, rivet, etc. FIG. 14B shows that the fan 416 is coupled to the heat dissipating fins 414 by female magnet and male magnet.

While FIG. 14A and FIG. 14B show that the radiator 410 may include the fan 416, the present disclosure is not limited thereto, and the fan 416 may be omitted. In these embodiments, the radiator pipes 412 and heat dissipating fins 414 may still exchange heat with the thermal energy provider and/or the conductive pads. By exposing the radiator pipes 412 and the heat dissipating fins 414 to the environment, the stimulator 400 may more efficiently exchange heat with the thermal energy provider and/or the conductive pads.

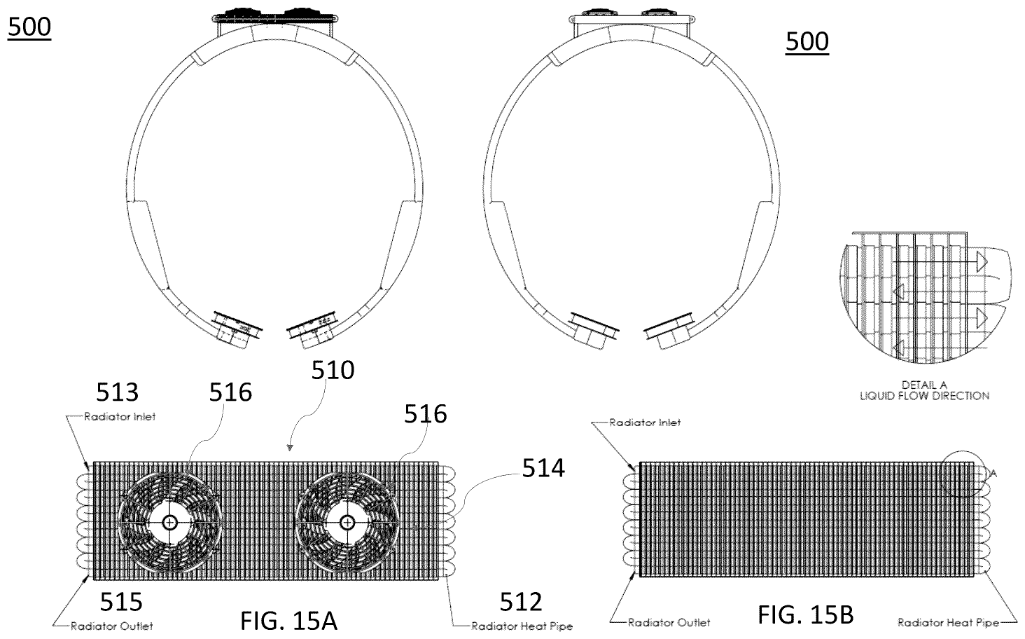

FIG. 15A and FIG. 15B illustrate a neckband stimulator 500 according to another embodiment. The neckband stimulator 500 is similar to the stimulator 400 of FIG. 14A and FIG. 14B except that the stimulator 500 includes a radiator 510 that includes longer (or wider) radiator pipes 512 and longer (or wider) heat dissipating fins 514 exposed to the environment. The stimulator 500 may also include two or more fans 516. The radiator pipes 512 may be sufficiently long or wide enough to exchange heat with both of the first thermal energy provider and the second thermal energy provider. In some embodiments, the radiator pipes 512 may have a single connected structure. In other embodiments, the radiator pipes 512 may include two separate pipe structures respectively exchanging heat with the first thermal energy provider and the second thermal energy provider. The radiator pipes 512 may include a radiator inlet 513 and a radiator outlet 515. While FIGS. 15A and 15B show that the radiator inlet 513 is disposed at the top of the radiator pipes 512 and the radiator outlet 515 is disposed at the bottom of the radiator pipes 512, the present disclosure is not limited thereto. For example, the radiator inlet 513 may be disposed at the bottom of the radiator pipes 512 and the radiator outlet 515 is disposed at the top of the radiator pipes 512.

FIG. 15A shows an example assembled state of the radiator 510, and FIG. 15B shows a partially disassembled state of the radiator 510. While FIG. 15A and FIG. 15B show that the radiator 510 includes the fans 516, the present disclosure is not limited thereto, and at least one of the fans 516 may be omitted. In these embodiments, the radiator pipes 512 and heat dissipating fins 514 may still exchange heat with the thermal energy provider and/or the conductive pads. By exposing the radiator pipes 512 and the heat dissipating fins 514 to the environment, the stimulator 500 may more efficiently exchange heat with the thermal energy provider and/or the conductive pads.

FIG. 16A and FIG. 16B illustrate a neckband stimulator 600 according to another embodiment. The neckband stimulator 600 is similar to the stimulator 200 of FIG. 12 except that the stimulator 600 is coupled with a chiller 210 as an external thermal energy source, and hoses (or pipes) 216 and 218 of the chiller 210 are coupled to the center portion of the stimulator 600.

The chiller 210 may communicate heat with the thermal energy provider using a fluid (liquid, gas, a combination thereof). For example, the chiller 210 may include one or more inlet hoses 216 and one or more outlet hoses 218. The one or more inlet hoses 216 may be coupled to a chiller inlet 212 and two or more inlet pipes (e.g., at least one inlet in each side) disposed inside the stimulator to supply the fluid, having a first temperature, from the chiller 210 to the thermal energy provider to exchange heat with the thermally conductive pads. The one or more outlet hoses 218 may be coupled to a chiller outlet 214 and two or more outlet pipes (e.g., at least one outlet in each side of the stimulator) disposed inside the stimulator to transport a heat-exchanged fluid, having a second temperature different from the first temperature, back to the chiller 210. The chiller 210 may include a power controller to turn on the chiller 210, and a temperature adjuster (not shown) to adjust a temperature of the fluid, etc. The temperature adjuster may also be separately provided and electrically coupled to the chiller 210.

The chiller 210 may include a compressor that moves a refrigerant through a heating or cooling system. In the cooling system, a gaseous refrigerant may flow into a condenser from the compressor through pressure. A fan may blow air over the condenser cooling the refrigerant inside and expelling heat into the atmosphere around the chiller 210. The cooled refrigerant may then cool a coil or block containing an inert liquid.

While FIG. 16B shows water as a type of fluid for heat exchange, the present disclosure is not limited thereto, and other types of fluid such as water vapor, liquid or gas coolant, air, or other fluid can be used.

FIG. 17 illustrates a neckband stimulator 700 according to another embodiment. The neckband stimulator 700 is similar to the stimulator 200 of FIG. 12 and the stimulator 600 of FIG. 16A and FIG. 16B except that an inlet tube 410 is branched into two sub-tubes, exposed to the environment, that are respectively coupled to the inlets of the first and second side portions (e.g., see FIG. 12). While FIG. 17 shows a single inlet tube 410 and a single outlet tube 420, the present disclosure is not limited thereto. For example, two or more inlet tubes may be provided for each side portion, and two or more outlet tubes may be provided for each side portion. The inlet tubes and the outlet tubes may be formed of an insulating material such that the fluid flowing therein may be thermally insulated from an external temperature.

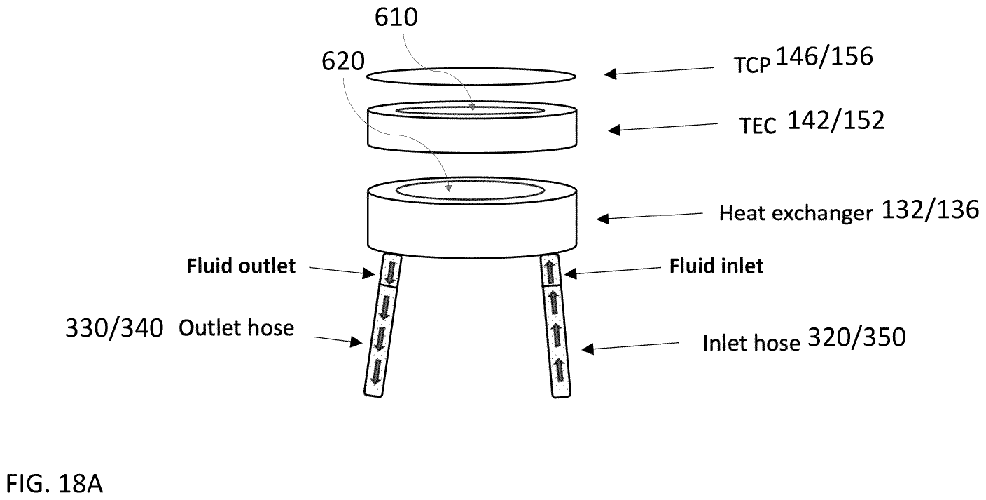

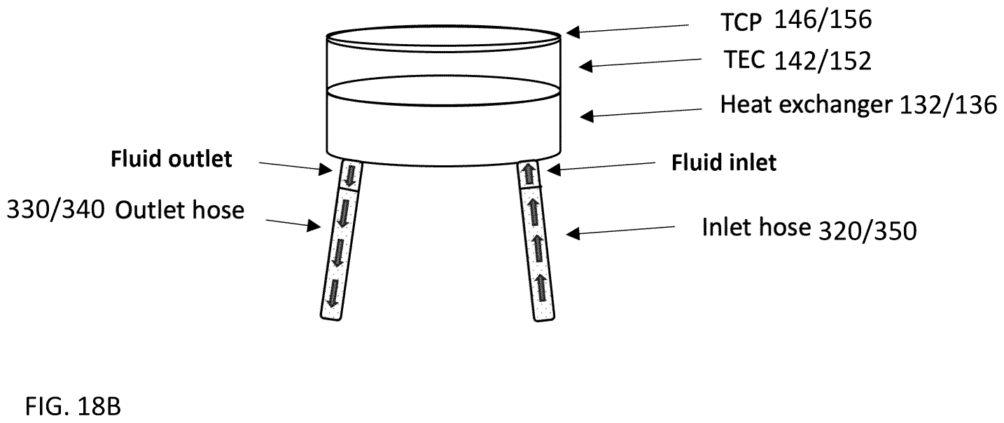

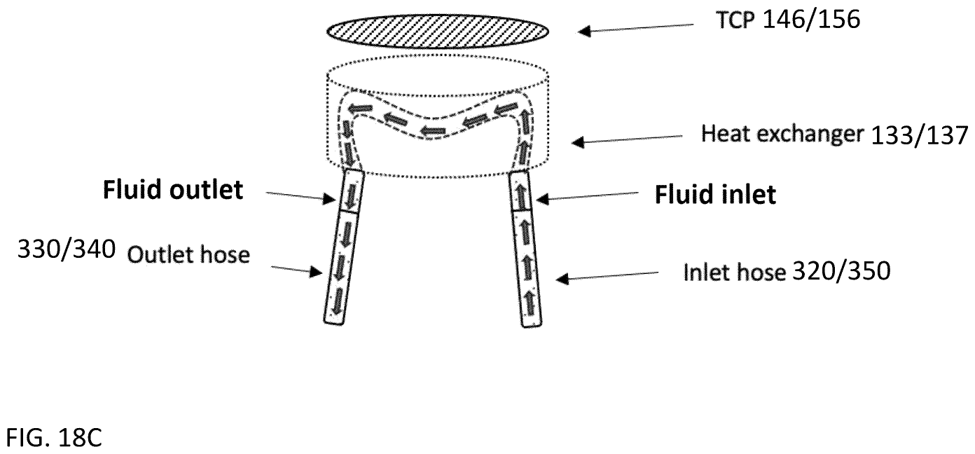

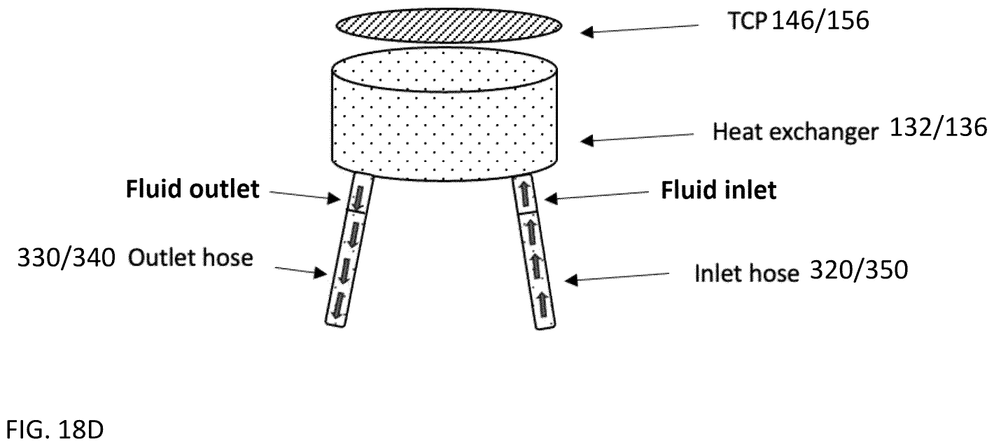

FIG. 18A and FIG. 18B illustrate an example configuration of a thermal energy provider according to some embodiments. FIG. 18A shows an example configuration of a disassembled thermal energy provider, and FIG. 18B shows an example configuration of an assembled thermal energy provider. As described above, the terminal energy provider may include at least one of a thermal energy generator 142/152 such as a thermoelectric heater or cooler (TEC), or a heat exchanger 132/136. The thermal energy generator 142/152 may be disposed between the conductive pad 146/156 and the heat exchanger 132/136. At least one of the thermal energy generator 142/152 or the heat exchanger 132/136 may include an opening 610/620 that can accommodate an exciter described above.

The heat exchanger 132/136 may receive an incoming fluid from an external thermal energy source and flow therethrough and output a heat-exchanged fluid. The incoming fluid may have a first temperature and the heat-exchanged fluid may have a second temperature different from the first temperature. The first temperature may be lower or higher than the second temperature depending at least one of the temperature of the conductive pad 146/156 or the temperature of the thermal energy generator 142/152.

The heat exchanger 132/136 may indirectly exchange heat with the conductive pad 146/156 via the thermal energy generator 142/152. The heat exchanger 132/136 may include a thermally conductive material, for example, copper, aluminum, carbon sheets, silicon thermal pads, aluminum nitride, or a combination thereof. The heat exchanger 132/136 may include a material having a relatively low electric conductivity while having a relatively high thermal conductivity.

In some embodiments, the thermal energy generator 142/152 may include a thermoelectric heater/cooler such as a Peltier module. The thermoelectric heater/cooler may include a first substrate facing the heat exchanger 132/136 and having a first temperature, and a second substrate facing the conductive pad 146/156 and having a second temperature different from the first temperature. The thermoelectric heater/cooler may generate a heating energy on one of the two substrates and a cooling energy on the other substrate when at least one of current, voltage, or power is applied thereto. For example, the thermoelectric heater/cooler may function as a cooler that transfers heat away from the patient's neck or a heater that transfers heat to the patient's neck. The thermoelectric heater/cooler is a solid-state active heat pump which can transfer heat from one side of the device to the other side of the device which is dependent on the direction of the current. One advantage of the solid-state heat pump is the lack of moving parts, resistance to vibration, low weight, and long useful life.

The heated substrate and the cooled substrate may maintain a fixed temperature difference therebetween while the same amount of current, voltage, or power is applied. For example, when the heated side (e.g., first substrate) is further heated by the heat exchanger, the cooled side (e.g., second substrate) may become warmer to maintain the fixed temperature difference. As another example, when the heated side (e.g., first substrate) is cooled by the heat exchanger, the cooled side (e.g., second substrate) may become cooler to maintain the fixed temperature difference. The temperature of the thermoelectric heater/cooler may be controlled using the above principle of maintaining the fixed temperature difference. As described above, one or more temperature sensors may be used to measure or sense the temperature of the thermoelectric heater/cooler or the temperature of the conductive pad. At least one of the electrical circuit or the PDA may adjust the temperature of the thermoelectric heater/cooler or the temperature of the conductive pad based on use the measured temperature. For example, at least one of the electrical circuit or the PDA may control the chiller or heat pump to provide a fluid having a certain temperature to the heat exchanger to control at least one of the temperature of the thermoelectric heater/cooler or the temperature of the conductive pad.

FIG. 18C illustrates another example configuration of a thermal energy provider according to some embodiments. In these embodiments, the thermal energy provider may include only a heat exchanger 132/136 (i.e., no thermal energy generator). The heat exchanger 132/136 may directly exchange heat with the thermally conductive pad 146/156 by flowing a fluid therethrough as described above with respect to FIG. 18A and FIG. 18B. The heat exchanger may include an interior configured to guide the incoming fluid to flow inside the heat exchanger by contacting at least the top surface of the heat exchanger 132/136 facing the thermally conductive pad 146/156 such that the heat can be transferred from the top surface of the heat exchanger 132/136 to the thermally conductive pad 146/156 (heating) or the heat can be transferred away from the thermally conductive pad 146/156 to the heat exchanger 132/136 (cooling). For example the heat exchanger may include one or more tubes or pipes that allow the fluid to flow therethrough by contacting the top surface of the heat exchanger 132/136. The one or more tubes may be linear, curved, or wound.

FIG. 18D shows another example configuration of a thermal energy provider. The thermal energy provider of FIG. 18D is similar to the thermal energy provider of FIG. 18C except that the heat exchanger 133/137 is formed of a substantially solid material. The solid material may include a porous material that allows for the incoming fluid to enter from the fluid inlet and pass through the interior surface of the heat exchanger 133/137 and exit via the fluid outlet.

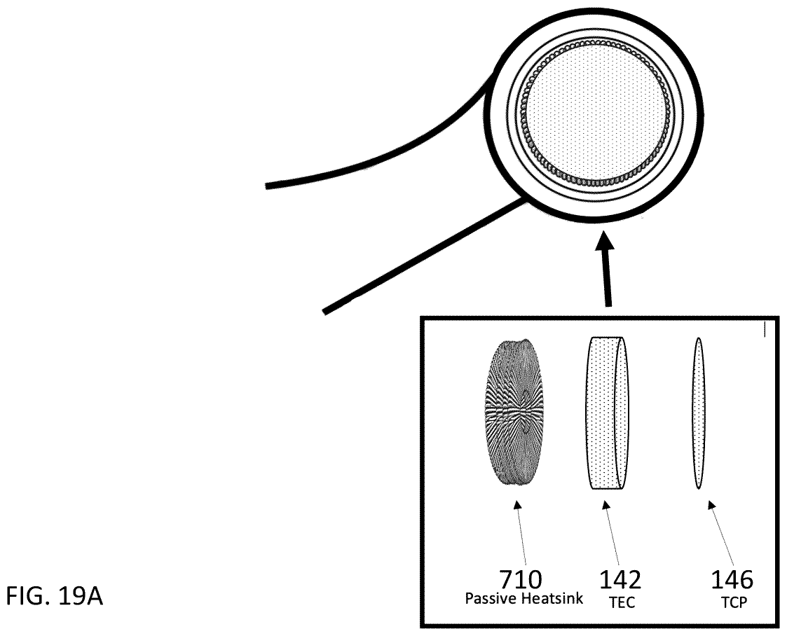

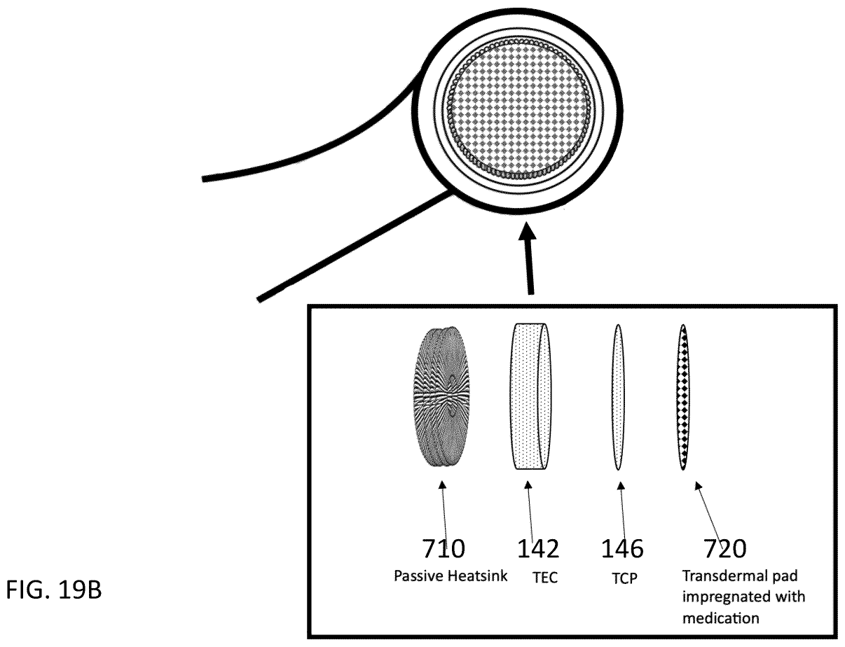

FIG. 19A shows an example configuration of a thermal energy provider and a heatsink. The thermal energy generator 142 (or 152) may be interposed between a passive heatsink 710 and a thermally conductive pad 146 (or 156). While the description below is provided for the thermal energy generator 142 for convenience, the same description may be used for the thermal energy generator 152. At least one of the passive heatsink 710 or the thermally conductive pad 146 may include an opening that can accommodate an exciter.

The temperature of the thermal energy generator 142 may be cooled or adjusted through various means of active or passive cooling. For example, as shown in FIG. 19A, the heat generated in the thermal energy generator 142 may be passively cooled by an internal passive heatsink 710 disposed inside the stimulator.

In some embodiments, as described above, the heat generated in the thermal energy generator 142 may be passively cooled by an external heatsink (disposed outside the stimulator) in contact with the external environment, whereby the heatsink is cooled by contact with the ambient air which then in turn acts to cool the thermal energy generator 142. In these embodiments, the external heatsink may include a fluid inlet or a fluid outlet (e.g., see FIG. 12).

The heat generated in the thermal energy generator 142 may be actively cooled whereby heat is dissipated by a heatsink in contact with the external environment using an active process such as a fan to blow on the heatsink. Furthermore, the heatsinks may be in local contact or distal contact with the thermal energy generator 142. For example, the active cooling may use an air cooler which passes air from the environment over a heatsink or radiator connected to the thermal energy generator 142 by heat pipes which contain a substance undergoing phase changes thereby reducing the temperature of the thermal energy generator 142 as described above. The benefits over a liquid cooled system may include a reduced risk of short circuits, arcing or other electric discharge. The liquid cooler including a liquid such as water or inert oil enclosed by a flexible or rigid hose in which one end of the enclosed hose is attached to a surface in contact with the surface of the thermal energy generator 142 and the other end of the hose attached to a radiator with a pump and a fan or fans to reduce the temperature of the thermal energy generator 142 as described above.

The temperature of the thermal energy generator 142 may be controlled by internal components of an electrical circuit. The internal components may include, but are not limited to, a controller, MOSFET, a brushless or brush ELM, or a buck-boost converter for regulating the temperature by controlling the current and/or voltage being applied to the thermal energy generator 142. The attending medical staff, the patient or the patient family member or person otherwise using the device may control or adjust the temperature of the thermal energy generator 142 directly on the neck device or indirectly using a PDA or other personal communication device such as a smartphone.

As described above, the thermal energy generator 142 may be omitted and the heatsink may function as a heat exchanger between the conductive pad 146 and the ambient air. In these embodiments, the passive heatsink 710 may be coupled to one or more heat pipes coupled to an external thermal energy source (environment, chiller, heat pump, etc.).

FIG. 19B shows another example configuration of a thermal energy provider and a heatsink. The configuration of FIG. 19B is similar to that of FIG. 19A except that a transdermal pad 720 is additionally provided. In the FIG. 19B embodiment, the thermal energy generator 142 may be omitted. The transdermal pad 720 may be disposable. The transdermal pad 720 may be attached to the conductive pad 146/156 of one or more of the stimulators described above.

The transdermal pad 720 may be impregnated with medication. When providing at least one of vibration, heating, or cooling on the patient's neck, the transdermal pad 720 may increase the permeability of the skin to allow for more efficacious drug delivery to the thyroid. This has the advantages of avoiding first-pass metabolism, targeting the thyroid, for which a drug such as a hormone or cortisol will be used, and increasing the delivery rate. Moreover, this offers a non-invasive route for drug administration and control over the drug delivery rate.

While the transdermal pad 720 could be at least partially adhesive, the transdermal pad 720 may not need to be adhesive as the conductive pad 146 and the transdermal pad 720 are pressed against the neck of the patient. The transdermal pad 720 may be implemented with a known transdermal patch, for example, described in U.S. Pat. No. 5,948,433, which is incorporated by reference in its entirety.

### Closed Front Stimulator

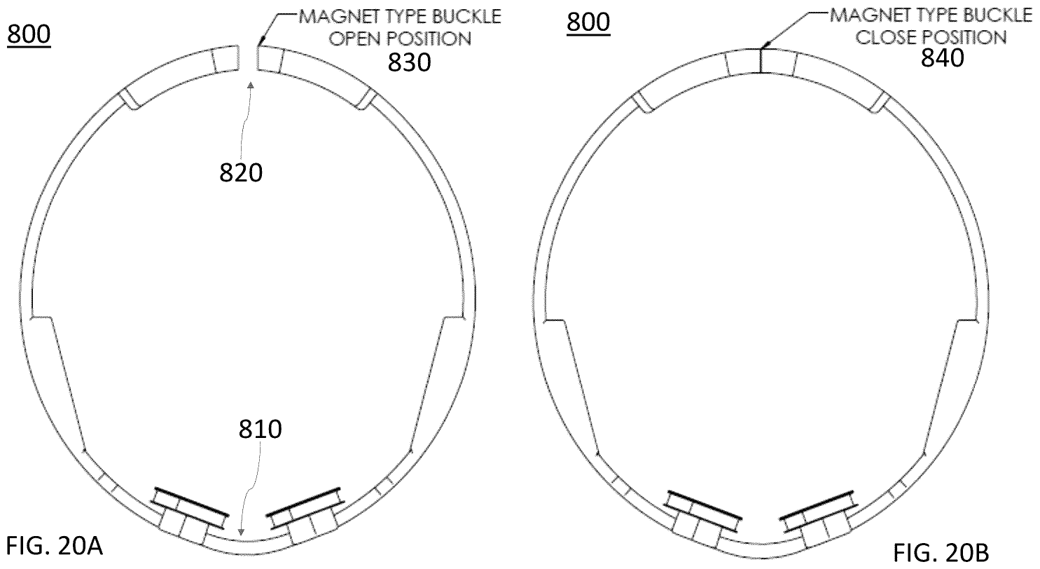

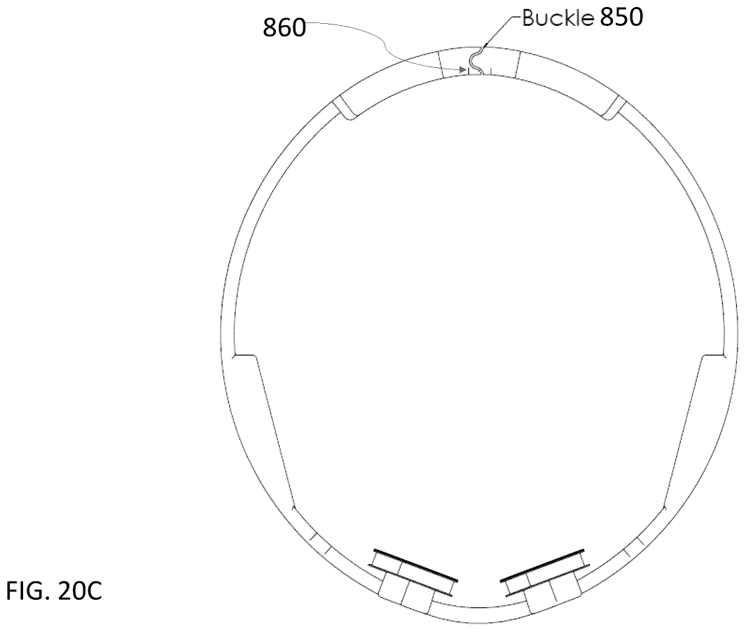

FIG. 20A-FIG. 20C illustrate an example neckband stimulator 800 according to some embodiments. The neckband stimulator 800 is similar to the stimulators described with respect to FIGS. 10A, 10B, 12-17, 19A, and 19B, except that the stimulator 800 includes a closed front portion 810. The closed front portion 810 may be implemented by connecting the first side portion and the second side portion of neckband stimulator 800. The supports, the thermal energy providers, and the conductive pads of each side may still be spaced apart from each other. The stimulator 800 may include an adjustable rear portion 820. The rear portion 820 may be opened and closed using a coupling mechanism. Examples of the coupling mechanism include, but are not limited to, Velcro, rubber, wire, spring, magnet, etc.

For the purpose of convenience, FIG. 20A and FIG. 20B show that the stimulator includes a magnet type coupling mechanism. FIG. 20A shows that the adjustable rear portion 820 is in the open position 830. FIG. 20B shows that the adjustable rear portion 820 is in the closed position 830. FIG. 20C shows that the adjustable rear portion 820 is in the closed position 830 by engaging a buckle 850 with a latch 860. Again, FIG. 20C shows merely examples of a coupling/decoupling mechanism, other coupling/decoupling mechanisms can also be used.

While not shown in FIG. 20A-FIG. 20C, the neckband stimulator 800 may include an open rear portion (i.e., maintained open). In these embodiments, the open rear portion is flexible enough to accommodate different necks of patients when in use.

### Thyroid Stimulation

Various embodiments may use at least one of vibration or thermal energy (heating or cooling) to stimulate the release of thyroid hormone. The stimulators may use a cooling energy alone, or together with vibration, to reduce overproduction of thyroid hormone, and to reduce inflammation. The stimulators may use a heating energy alone, or together with vibration, to increase the permeability of the skin allowing for drug delivery to the thyroid which has the advantages of avoiding first pass metabolism, targeting the thyroid for which the drug will be used, and an increased delivery rate over the conventional technology.

One or more of the above described stimulators (FIGS. 1-20) may be used to thermally and/or vibrationally stimulate the thyroid. For example, while FIG. 1A-FIG. 8 show various laryngeal nerve exciters configured to excite a laryngeal nerve of a person, the exciters can also be used to stimulate the thyroid of the person.

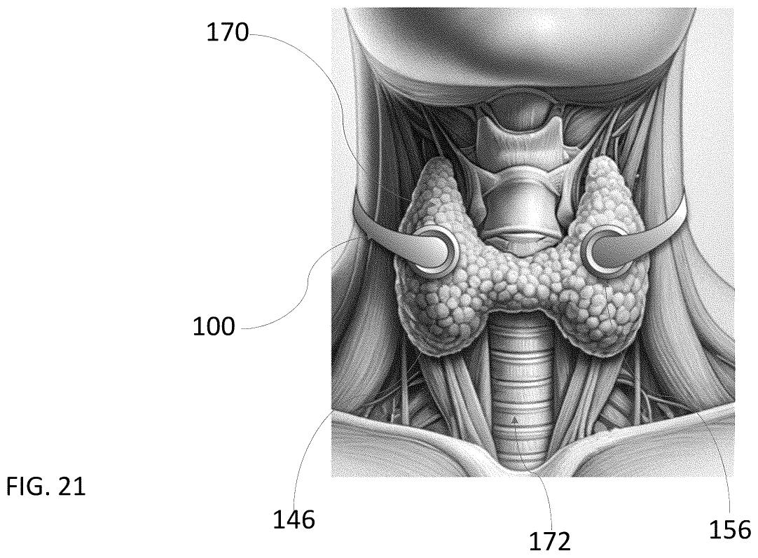

FIG. 21 illustrates an example anatomy of a thyroid 170 and a trachea 172 of a person. The conductive pads 146/156 of an example neckband stimulator 100 are placed on a neck portion where the thyroid 170 is positioned to thermally and/or vibrationally stimulate the thyroid 170.

The endocrine system is vital for the production, release and reduction hormones. An endocrine disorder is a dysfunction of an endocrine organ can have major implications for an individual. One such disorder is hypothyroidism, a deficiency in the production, or release of thyroid hormone that affects approximately 5% of the population.

The thyroid is an endocrine gland located in the neck, in front of the trachea just below the laryngeal prominence and above the collarbones and a few millimeters deep from the skin; and proximate to the external branch of the superior laryngeal nerve and the recurrent laryngeal nerve. The thyroid structurally resembles a butterfly, with two lobes on either side of the trachea connected by a narrow band of tissue called the isthmus. The thyroid influences the metabolism of the entire body through the secretion of hormones into the bloodstream.

The thyroid is a part of the HPT axis, which includes hypothalamus and the pituitary gland. The hypothalamus produces thyroid releasing hormone (TRH) which is released into the hypophyseal portal system and induces the anterior pituitary to produce and secrete Thyroid Stimulating Hormone (TSH) into the blood. TSH then acts on the thyroid to induce the synthesis and subsequent release of thyroid hormones namely two lipid hormones triiodothyronine (T3) and thyroxine (T4). Levels of serum thyroid hormones are tightly regulated by the hypothalamic-pituitary-thyroid axis. Following the secretion of T3 and T4 there is an increase in the concentration of free T3 and T4 which inhibits the release of TRH in the hypothalamus and TSH in the anterior pituitary by negative feedback loop. Other hormones, such as somatostatin, glucocorticoids, and dopamine, also inhibit TSH production. Whereas cold, stress, and exercise increase TRH release and consequently (T3 and T4) production and release.

The thyroid follicle is lined with follicular cells which are in contact with a cavity filled with a homogenous gelatinous material called colloid. The colloid includes thyroglobulin, a large, iodinated glycoprotein, a precursor of thyroid hormone. The space between the follicles is filled with connective tissue stroma, numerous capillaries (including perforated capillaries), and lymphatic vasculature. Furthermore, it is the only endocrine gland whose secretory products are stored extracellularly in significant quantity.

Issues with the thyroid may occur at the various locations within the HPT axis. If the issue arises centrally from the thyroid gland (primary), peripherally from the pituitary (secondary), or hypothalamus (tertiary). In primary hypothyroidism, the thyroid gland is not releasing sufficient thyroid hormones. Hypothyroidism may produce symptoms such as cold intolerance, muscle weakness, dry skin, hair thinning/loss, weight gain, changes in mood, poor concentration, pain or aching.

Hypothyroidism often is characterized by a decrease in thyroid hormone production that stems in part from a reduction in thyroid epithelial cell sensitivity to thyroid stimulating hormone (TSH). In order for the thyroid hormones, T3 and T4, to be produced, iodine must be transported into the thyroid epithelial cells through the sodium iodine symporter (NIS). Iodine must then be oxidized by thyroid peroxidase (TPO) and the reactive oxygen species (ROS) hydrogen peroxide (H₂O₂) and added to the tyrosine residues of thyroglobulin (TG). The iodized tyrosine residues are then cleaved to form the thyroid hormones triiodothyronine (T3) and thyroxine (T4), which are critical for regulating cell metabolism, growth, and development.

Hyperthyroidism is a medical condition characterized by the overproduction of thyroid hormones by the thyroid gland. These hormones, mainly thyroxine (T4) and triiodothyronine (T3), play a crucial role in regulating the body's metabolism. When the thyroid gland produces too much of these hormones, it can accelerate the body's metabolic processes significantly. Common symptoms of hyperthyroidism include weight loss, rapid heartbeat, increased appetite, nervousness, anxiety, tremors, sweating, changes in menstrual patterns, sensitivity to heat, and more frequent bowel movements. In some cases, individuals may also experience a swelling in the neck due to an enlarged thyroid gland, known as a goiter.

Small bursts of low frequency stimulation increase diffusion in the thyroid (particularly the colloids) and blood perfusion of the thyroid. The thyroid gland is regularly exposed to different types of mechanical vibrations due to bodily movements. Vibrations significantly influence hormone regulation and the production of ROS in the endocrine system. Additionally, vibrations from the vocal cords during speaking provide mechanical vibration stimuli to the thyroid, which are crucial in modulating its hormone production. Vibrations of the thyroid can enhance thyroid epithelial cell function and aid in efficacious hormone regulation and the production of ROS. Vibrations applied by the vibrating laryngeal nerve exciting device will vibrate the vocal folds and thyroid and may augment existing treatments of diseases related to the thyroid.

Vibration can aid in the diffusion of molecules. Blood and cytoplasm are a shear-thinning fluid, meaning that its viscosity decreases when shear rate increases. Viscosity is a macroscopic outcome of the dynamics of molecules constituting a liquid. According to Stokes-Einstein equation, the translation diffusion coefficient is inversely proportional to liquid viscosity (for a given molecular radius and temperature). Likewise, heat induces diffusion of molecules. For instance, heating the thyroid and surrounding vessels increases blood perfusion in the thyroid. Furthermore, generally in liquids, viscosity is a result of intermolecular attractive forces (cohesive forces) between compounds across layers of flow. Consequently, as the temperature increases the viscosity decreases because of the energy of the compound is so great that it can more easily overcome those attractive forces. Therefore, heat and vibration independently or together make the shear-thinning fluid less viscous. As a result, the rate of diffusion will increase in response to heat and vibration together or alone.

Exposure of the skin to higher temperatures for longer exposure times increases the permeability and absorption by local tissue targets and capillaries. Furthermore, 0.1 second to 1 second flash exposures to the skin to higher temperatures >100° C., can dramatically increase skin permeability.

The application of cold reduces diffusion of molecules. For instance, cooling the thyroid and surrounding vessels decreases blood perfusion in the thyroid. Furthermore, generally in liquids, viscosity is a result of intermolecular attractive forces (cohesive forces) between compounds across layers of flow. Consequently, as the temperature decreases the viscosity increases. Therefore, cold makes fluid more viscous. As a result, the rate of diffusion will decrease in response to cold temperatures.

The thyroid is in close proximity to the skin. Consequently, one or more of vibration, heat, or cooling of the skin proximal to the thyroid, is transferred to the thyroid. Furthermore, vibration, and heat increase the permeability of the skin to the transdermal target with or without micro needling. As a result, medication applied to permeable skin in close proximity to the thyroid, will be absorbed by the thyroid. In addition, transdermal drug delivery offers a non-invasive route for drug administration and control over the drug delivery rate. For example, transdermal hormone patches have been used as a for hormone replacement of estradiol.

As described above, various embodiments may use heat and vibration together or alone to stimulate the release of thyroid hormone. One or more stimulators described above may also use a cooling energy, or a cooling energy with vibration, to reduce overproduction of thyroid hormone, and to reduce inflammation.

Various embodiments may also use a snap thermal conductive pad together with a transdermal pad impregnated with hormone or other medication. Various embodiments may provide a means of providing at least one of a thermal energy or vibration to increase the permeability of the skin allowing for drug delivery to the thyroid in conjunction with the advantages of avoiding first pass metabolism, targeting the thyroid for which the drug will be used, and an increased delivery rate. Various embodiments provide a non-invasive route for drug administration and control over the drug delivery rate.

As described with respect to FIG. 19B, at least one of the stimulators describe above may use a thermally conductive pad, together with a transdermal pad, with or without microneedles, impregnated with hormone or other medication, and about 0.1 to about 1 second flash exposures to the skin to higher temperatures >about 100° C., to dramatically increase skin permeability allowing for drug delivery to the thyroid in conjunction with the advantages of avoiding first pass metabolism, targeting the thyroid for which the drug will be used, and an increased delivery rate over the conventional technology.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount.

The scope of the present disclosure is not intended to be limited by the specific disclosures of embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive. It should be emphasized that many variations and modifications may be made to the above-described embodiments, the elements of which are to be understood as being among other acceptable examples. All such modifications and variations are intended to be included herein within the scope of this disclosure and protected by the following claims.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the implementations are not limited to the precise configuration and components illustrated above. Various modifications, changes and variations may be made in the arrangement, operation and details of the methods and apparatus described above without departing from the scope of the implementations.

Although the present disclosure has been described in terms of certain embodiments, other embodiments that are apparent to those of ordinary skill in the art, including embodiments that do not provide all of the features and advantages set forth herein, are also within the scope of this invention. Moreover, the various embodiments described above can be combined to provide further embodiments. In addition, certain features shown in the context of one embodiment can be incorporated into other embodiments as well.

What is claimed is:

1. A method of stimulating a thyroid to treat one or more thyroid related diseases, the method comprising:
providing a thyroid stimulation system comprising:
a neckband stimulator comprising:
a center portion,
a first side portion and a second side portion disposed on opposite sides of the center portion,
a first extension comprising a first surface and a second surface opposing each other, the first surface extending from the first side portion,
a second extension comprising a first surface and a second surface opposing each other, the first surface of the second extension extending from the second side portion,
a first support coupled to the second surface of the first extension,
a second support coupled to the second surface of the second extension, the first support and the second support opposing each other and spaced apart by a distance,
a first exciter coupled to the first support,
a second exciter coupled to the second support,
a first electrical circuit and a second electrical circuit configured to respectively control the first exciter and the second exciter,
a first pad coupled to the first exciter, and
a second pad coupled to the second exciter,
wherein each of the first side portion and the second side portion comprises a first region and a second region closer to the center portion than the first region, wherein each first region comprises a housing mounted thereon and respectively accommodating the first electrical circuit or the second electrical circuit, and wherein each first region is larger in size than each second region due to the housing;
placing the neckband stimulator at least partially around a neck of a patient;
moving the neckband stimulator such that the first pad and the second pad respectively contact a first portion and a second portion of the neck of the patient different from each other and adjacent to the thyroid of the patient; and
vibrationally exciting the thyroid of the patient, the vibrationally exciting including generating vibration, by the first exciter and the second exciter, and conducting, by the first exciter and the second exciter, the generated vibration to the first portion and the second portion of the neck.

2. The method of claim 1, wherein the first support and the second support are not coupled to each other to form an open front of the neckband stimulator facing the center portion.

3. The method of claim 1, wherein the first side portion and the second side portion are coupled to each other to form a closed front of the neckband stimulator.

4. The method of claim 1, wherein the center portion is divided by two sub-portions configured to be detached from or attached to each other.

5. The method of claim 1, wherein the first extension and the second extension respectively extend from the first side portion and the second side portion in a curved manner.

6. The method of claim 1, wherein at least one of a length of the first side portion or a length of the second side portion is adjustable.

7. The method of claim 1, wherein the neckband stimulator further comprises:
a first thermal energy provider coupled to at least one of the first support or the first exciter, the first thermal energy provider comprising a first surface and a second surface opposing each other, the second surface of the first thermal energy provider facing the first support, the first thermal energy provider configured to provide a thermal energy on the first surface thereof;
a second thermal energy provider coupled to at least one of the second support or the second exciter, the second thermal energy provider comprising a first surface and a second surface opposing each other, the second surface of the second thermal energy provider facing the second support, the second thermal energy provider configured to provide a second thermal energy on the first surface thereof, the second thermal energy provider spaced apart from the first thermal energy provider;
the first pad in thermal communication with the first surface of the first thermal energy provider, the first pad comprising a first thermally conductive pad; and
the second pad in thermal communication with the first surface of the second thermal energy provider, the second pad comprising a second thermally conductive pad,
the method further comprising:
thermally stimulating the thyroid of the patient by controlling at least one of the first thermal energy provider or the second thermal energy provider to provide at least one of the first thermal energy or the second thermal energy and thermally conduct heat away from or to the thyroid of the patient through at least one of the first thermally conductive pad or the second thermally conductive pad.

8. The method of claim 7, wherein vibrationally exciting the thyroid of the patient is performed while thermally stimulating the thyroid of the patient.

9. The method of claim 7, wherein the vibrationally exciting and the thermally stimulating are alternately and repeatedly performed.

10. The method of claim 7, wherein the vibrationally exciting and the thermally stimulating are sequentially performed.

11. The method of claim 7, further comprising:
providing one or more temperature sensors adjacent to or on the at least one of the first exciter or the second exciter; and
measuring a temperature of the at least one of the first exciter or the second exciter using the one or more temperature sensors,
wherein controlling the at least one of the first thermal energy provider or the second thermal energy provider is performed based on the measured temperature.

12. The method of claim 7, wherein the first exciter is coupled to the first surface of the first thermal energy provider so as to be interposed between the first thermal energy provider and the first thermally conductive pad, and
wherein the second exciter is coupled to the first surface of the second thermal energy provider so as to be interposed between the second thermal energy provider and the second thermally conductive pad.

13. The method of claim 7, wherein at least one of the first thermal energy provider or the second thermal energy provider comprises an opening at least partially accommodating the respective first or second exciter therein.

14. The method of claim 7, wherein the first exciter is coupled to the second surface of the first thermal energy provider, and
wherein the second exciter is coupled to the second surface of the second thermal energy provider.

15. The method of claim 14, wherein at least one of the first thermal energy provider or the second thermal energy provider comprises an opening at least partially accommodating the respective first or second exciter therein.

16. The method of claim 7, wherein the first electrical circuit is configured to control both the first thermal energy provider and the first exciter, and wherein the second electrical circuit is configured to control both the second thermal energy provider and the second exciter.

17. The method of claim 7, further comprising:
providing one or more temperature sensors on at least one of the first thermally conductive pad, the second thermally conductive pad, the first side portion, the second side portion, or the center portion; and
measuring a temperature of the neck of the patient using the one or more temperature sensors,
wherein controlling the at least one of the first thermal energy provider or the second thermal energy provider is performed based on the measured temperature.

18. The method of claim 7, further comprising:
providing one or more temperature sensors adjacent to or on the at least one of the first thermal energy provider or the second first thermal energy provider; and
measuring a temperature of the at least one of the first thermal energy provider or the second first thermal energy provider,
wherein controlling the at least one of the first thermal energy provider or the second thermal energy provider is performed based on the measured temperature.

19. The method of claim 18, further comprising:
generating an alarm in response to the measured temperature exceeding a threshold.

20. The method of claim 7, further comprising:
controlling, by at least one of the first electrical circuit or the second electrical circuit, at least one of the first thermal energy provider or the second thermal energy provider by applying at least one of voltage, current, or power to the first thermal energy provider or the second thermal energy provider.

21. The method of claim 7, wherein the at least one of the first thermal energy provider or the second first thermal energy provider comprises a thermoelectric heater or cooler configured to generate a heating or cooling energy based on at least one of voltage, current, or power received from an electrical circuit and provide the heating or cooling energy to the respective first or second thermally conductive pad.

22. The method of claim 7, wherein the first thermal energy provider comprises a first thermoelectric heater or cooler configured to generate a first heating or cooling energy based on at least one of a first voltage, a first current, or a first power received from a first electrical circuit and provide the first heating or cooling energy to the first thermally conductive pad, and
wherein the second thermal energy provider comprises a second thermoelectric heater or cooler configured to generate a second heating or cooling energy based on at least one of a second voltage, a second current, or a second power received from a second electrical circuit and provide the second heating or cooling energy to the second thermally conductive pad.

23. The method of claim 7, wherein the at least one of the first thermal energy provider or the second first thermal energy provider comprises a heat exchanger in thermal communication with the respective first or second thermally conductive pad and configured to receive a heating or cooling energy from an external thermal energy source and exchange the received heating or cooling energy with the respective first or second thermally conductive pad.

24. The method of claim 23, wherein the neckband stimulator comprises one or more heat pipes disposed inside the neckband stimulator and in thermal communication with the heat exchanger and the external thermal energy source such that the heating or cooling energy is transferred from the external thermal energy source to the heat exchanger or dissipated from the heat exchanger to the external thermal energy source through the one or more heat pipes.

25. The method of claim 24, further comprising:
providing one or more temperature sensors adjacent to or on the one or more heat pipes; and
measuring a temperature of the one or more heat pipes using the one or more temperature sensors,
wherein controlling the at least one of the first thermal energy provider or the second thermal energy provider is performed based on the measured temperature.

26. The method of claim 24, wherein the neckband stimulator comprises one or more inlets and one or more outlets in thermal communication with the heat exchanger and the external thermal energy source through the one or more heat pipes,
the method further comprising:
receiving, via the one or more inlets, a fluid having a first temperature from the external thermal energy source;
flowing the fluid from the external thermal energy source to the heat exchanger through the one or more heat pipes such that the fluid exchanges heat with the heat exchanger and the respective thermally conductive pad to output a temperature-adjusted fluid having a second temperature different from the first temperature; and
dissipating the temperature-adjusted fluid from the heat exchanger to the external thermal energy source through the one or more outlets.

27. The method of claim 26, wherein the thyroid stimulation system further comprises a chiller or a heat pump coupled to the neckband stimulator via one or more fluid pipes external to the neckband stimulator.

28. The method of claim 26, further comprising:
providing a first temperature sensor adjacent to or on the first thermal energy provider;
providing a second temperature sensor adjacent to or on the first thermal energy provider;
measuring a first temperature of the first thermal energy provider;
measuring a second temperature of the second thermal energy provider;
in response to the first temperature being different from the second temperature, causing a temperature gradient between the first thermal energy provider and the second thermal energy provider; and
transferring a thermal energy difference caused by the temperature gradient, by the first thermal energy provider and the second thermal energy provider, to or from the patient's neck.

29. The method of claim 1, further comprising:
prior to moving the neckband stimulator, coupling a first transdermal pad impregnated with medication to the first pad and coupling a second transdermal pad impregnated with the medication to the second pad,
wherein the moving comprises moving the neckband stimulator such that the first transdermal pad and the second transdermal pad respectively contact a first portion and a second portion of the neck of the patient different from each other, and
wherein vibrationally exciting the thyroid comprises:
generating vibration, by the first exciter and the second exciter, and conducting, by the first exciter and the second exciter, the generated vibration to the patient's neck to facilitate the medication to be delivered to the thyroid.

30. The method of claim 7, further comprising:
prior to moving the neckband stimulator and prior to thermally stimulating the thyroid, coupling a first transdermal pad impregnated with medication to the first pad and coupling a second transdermal pad impregnated with the medication to the second pad, wherein thermally stimulating the thyroid comprises:
providing the first thermal energy and the second thermal energy respectively to the first transdermal pad and the second transdermal pad to facilitate the medication to be delivered to the thyroid.

31. The method of claim 7, wherein controlling the at least one of the first thermal energy provider or the second thermal energy provider comprises:
wirelessly controlling, by a personal information communication device, at least one of the first thermal energy provider or the second thermal energy provider to provide at least one of the first thermal energy or the second thermal energy and thermally conduct heat away from or to the laryngeal nerve.
